(19) United States
(12) Patent Application Publication
(10) Pub. No.: US 2026/0067037 A1
(43) Pub. Date: Mar. 5, 2026

(54) CANCELATION OF SEMI-PERSISTENT SCHEDULING PHYSICAL DOWNLINK SHARED CHANNEL

(71) Applicant: QUALCOMM Incorporated, San Diego, CA (US)

(72) Inventors: Mostafa KHOSHNEVISAN, San Diego, CA (US); Jing SUN, San Diego, CA (US); Yi HUANG, San Diego, CA (US)

(21) Appl. No.: 18/817,043

(22) Filed: Aug. 27, 2024

(51) Int. Cl. H04L 1/1829; H04L 1/1812; H04L 5/00; H04W 72/232

(52) U.S. Cl. CPC H04L 1/1854; H04L 1/1812; H04L 5/0055; H04W 72/232

(57) ABSTRACT

Methods, systems, and devices for wireless communications are described. Various aspects generally relate to cancelation of semi-persistent scheduling (SPS) physical downlink shared channel (PDSCH) transmissions, and more particularly to cancelation of an SPS PDSCH transmission that follows an unsuccessfully received PDSCH transmission that has the same hybrid automatic repeat request (HARQ) identifier (ID) as the SPS PDSCH. In some aspects, a user equipment (UE) may refrain from monitoring for a scheduled SPS PDSCH transmission that has a same HARQ ID as a PDSCH transmission for which the UE transmitted a negative acknowledgment (NACK). In some aspects, a network entity may cancel (for example, may not transmit) a scheduled SPS PDSCH transmission that has a same HARQ ID as a PDSCH transmission for which the network entity received a NACK. The NACKed PDSCH transmission may be a DG PDSCH transmission or a prior SPS PDSCH transmission.

### TECHNICAL FIELD

The following relates to wireless communications, including cancelation of semi-persistent scheduling physical downlink shared channel.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communication systems, such as 5G wireless communication systems, may support semi-persistent scheduling (SPS) physical downlink shared channel (PDSCH) transmissions and dynamic grant (DG) PDSCH transmissions. Resources for SPS PDSCH transmissions may be periodically configured, and a set of hybrid automatic repeat request (HARQ) identifiers (IDs) for SPS PDSCH transmissions may be configured via radio resource control (RRC) signaling. A DG PDSCH transmissions may be scheduled dynamically via downlink control information (DCI), and the DCI that schedules the DG PDSCH transmission indicates the HARQ ID for the DG PDSCH transmission. In some cases, the network may use the same HARQ ID for an SPS PDSCH transmission and a DG PDSCH transmission. In such cases, when a DG or SPS PDSCH transmission is not successfully received at the UE, and that PDSCH transmission is followed by an SPS PDSCH transmission with the same HARQ ID, the UE may flush bits for the unsuccessfully-received PDSCH transmission from a HARQ buffer. As a result, the UE is not able to use the flushed bits to combine with bits from a retransmission of the previously unsuccessfully-received PDSCH transmission.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a user equipment (UE). The method may include receiving control signaling that schedules a set of semi-persistent scheduling (SPS) physical downlink shared channel (PDSCH) transmissions, transmitting a negative acknowledgment (NACK) for a first PDSCH transmission, the first PDSCH transmission associated with a first hybrid automatic repeat request (HARQ) identifier (ID), and refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

Another innovative aspect of the subject matter described in this disclosure can be implemented in UE. The UE may include a processing system that includes processor circuitry and memory circuitry that stores code. The processing system may be configured to cause the UE to receive control signaling that schedules an SPS PDSCH transmissions, transmit a NACK for a first PDSCH transmission, the first PDSCH transmission associated with a first HARQ ID, and refrain from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

Another innovative aspect of the subject matter described in this disclosure can be implemented in a UE for wireless communication. The UE may include means for receiving control signaling that schedules a set of SPS PDSCH transmissions, means for transmitting a NACK for a first PDSCH transmission, the first PDSCH transmission associated with a first HARQ ID, and means for refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

Another innovative aspect of the subject matter described in this disclosure can be implemented in non-transitory computer-readable medium storing code for wireless communication. The code may include instructions executable by one or more processors to receive control signaling that schedules a set of SPS PDSCH transmissions, transmit a NACK for a first PDSCH transmission, the first PDSCH transmission associated with a first HARQ ID, and refrain from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

Some examples of the method, UEs, and non-transitory computer-readable medium described herein may further include operations, features, means, or instructions for starting a timer in accordance with transmission of the NACK, and refraining from monitoring for the SPS PDSCH transmission is associated with the SPS PDSCH transmission being scheduled in a duration after starting the timer and before an expiration of the timer.

Some examples of the method, UEs, and non-transitory computer-readable medium described herein may further include operations, features, means, or instructions for monitoring for a second SPS PDSCH transmission of the set of SPS PDSCH transmissions, where the second SPS PDSCH transmission may be associated with a second HARQ ID, transmitting a first acknowledgment for the second SPS PDSCH transmission, receiving, from a network entity and subsequent to the second SPS PDSCH transmission, downlink control information (DCI) that schedules a dynamic grant (DG) PDSCH transmission, where the DCI indicates that the DG PDSCH transmission may be associated with the second HARQ ID, and where the DCI includes an indication that the network entity canceled the second SPS PDSCH transmission, and transmitting, in association with the DG PDSCH transmission being associated with the same HARQ ID and in association with the transmission of the first acknowledgment, a second acknowledgment for the DG PDSCH transmission.

Some examples of the method, UEs, and non-transitory computer-readable medium described herein may further include operations, features, means, or instructions for monitoring for a second PDSCH transmission associated with a second HARQ ID, transmitting a second NACK for the second PDSCH transmission, monitoring for, subsequent to transmitting the second NACK, a second SPS PDSCH transmission of the set of SPS PDSCH transmissions, where the second SPS PDSCH transmission may be associated with the second HARQ ID, receiving, from a network entity and subsequent to the second SPS PDSCH transmission, DCI that schedules a DG PDSCH transmission, where the DCI indicates that the DG PDSCH transmission may be associated with the second HARQ ID, where the DCI includes an indication that the network entity canceled the second SPS PDSCH transmission, and monitoring for the DG PDSCH transmission in accordance with the DCI and in accordance with an interpretation that a new data indicator associated with the second HARQ ID indicates that the DG PDSCH transmission includes new data, where the interpretation may be in association with transmission of the second NACK and the indication that the network entity canceled the second SPS PDSCH transmission.

Some examples of the method, UEs, and non-transitory computer-readable medium described herein may further include operations, features, means, or instructions for receiving, from a network entity and subsequent to the SPS PDSCH transmission, DCI that schedules a DG PDSCH transmission, where the DCI indicates that the DG PDSCH transmission may be associated with the same HARQ ID, and where the DCI includes an indication that the network entity canceled the SPS PDSCH transmission and monitoring for the DG PDSCH transmission in accordance with the DCI and in accordance with an interpretation that a new data indicator associated with the same HARQ ID that the DG PDSCH transmission includes retransmitted data, where the interpretation may be in accordance with the transmission of the NACK and the indication that the network entity canceled the SPS PDSCH transmission.

Some examples of the method, UEs, and non-transitory computer-readable medium described herein may further include operations, features, means, or instructions for receiving, from a network entity and subsequent to the SPS PDSCH transmission, DCI that schedules a DG PDSCH transmission, where the DCI indicates that the DG PDSCH transmission may be associated with the same HARQ ID, and where the DCI includes an indication that the network entity transmitted the SPS PDSCH transmission and monitoring for the DG PDSCH transmission in accordance with the DCI and in accordance with an interpretation that a new data indicator associated with the same HARQ ID indicates that the DG PDSCH transmission includes new data, where the interpretation may be in accordance with the indication that the network entity transmitted the SPS PDSCH transmission.

Another innovative aspect of the subject matter described in this disclosure can be implemented in method for wireless communication by a network entity. The method may include transmitting, to a UE, control signaling that schedules a set of semi-persistent scheduling SPS PDSCH transmissions, receiving, from the UE, a NACK for a first PDSCH transmission, the first PDSCH transmission associated with a first HARQ ID, and refraining from transmitting, subsequent to and in accordance with reception of the NACK, an SPS PDSCH transmission of the set of SPS PDSCH transmissions in accordance with the SPS PDSCH transmission being associated with the same HARQ ID.

Another innovative aspect of the subject matter described in this disclosure can be implemented in a network entity. The network entity may include a processing system that includes processor circuitry and memory circuitry that stores code. The processing system may be configured to cause the network entity to transmit, to a UE, control signaling that schedules a set of SPS PDSCH transmissions, receive, from the UE, a NACK for a first PDSCH transmission, the first PDSCH transmission associated with a first HARQ ID, and refrain from transmitting, subsequent to and in accordance with reception of the NACK, an SPS PDSCH transmission of the set of SPS PDSCH transmissions in accordance with the SPS PDSCH transmission being associated with the same HARQ ID.

Another innovative aspect of the subject matter described in this disclosure can be implemented in a network entity. The network entity may include means for transmitting, to a UE, control signaling that schedules a set of SPS PDSCH transmissions, means for receiving, from the UE, a NACK for a first PDSCH transmission, the first PDSCH transmission associated with a first HARQ ID, and means for refraining from transmitting, subsequent to and in accordance with reception of the NACK, an SPS PDSCH transmission of the set of SPS PDSCH transmissions in accordance with the SPS PDSCH transmission being associated with the same HARQ ID.

Another innovative aspect of the subject matter described in this disclosure can be implemented in a non-transitory computer-readable medium storing code for wireless communication. The code may include instructions executable by one or more processors to transmit, to a UE, control signaling that schedules a set of SPS PDSCH transmissions, receive, from the UE, a NACK for a first PDSCH transmission, the first PDSCH transmission associated with a first HARQ ID, and refrain from transmitting, subsequent to and in accordance with reception of the NACK, an SPS PDSCH transmission of the set of SPS PDSCH transmissions in accordance with the SPS PDSCH transmission being associated with the same HARQ ID.

Some examples of the method, network entities, and non-transitory computer-readable medium described herein may further include operations, features, means, or instructions for starting a timer in accordance with reception of the NACK, and refraining from transmitting the SPS PDSCH transmission is associated with the SPS PDSCH transmission being scheduled in a duration after starting the timer and before an expiration of the timer.

Some examples of the method, network entities, and non-transitory computer-readable medium described herein may further include operations, features, means, or instructions for transmitting, to the UE, a second SPS PDSCH transmission of the set of SPS PDSCH transmissions, where the second SPS PDSCH transmission may be associated with a second HARQ ID, transmitting, to the UE and subsequent to the second SPS PDSCH transmission, DCI that schedules a DG PDSCH transmission, where the DCI indicates that the DG PDSCH transmission may be associated with the second HARQ ID, where the DCI includes an indication that the network entity transmitted the second SPS PDSCH transmission, and transmitting the DG PDSCH transmission in accordance with the DCI.

Some examples of the method, network entities, and non-transitory computer-readable medium described herein may further include operations, features, means, or instructions for refraining from transmitting a second SPS PDSCH transmission of the set of SPS PDSCH transmissions, where the second SPS PDSCH transmission may be associated with a second HARQ ID, transmitting, to the UE and subsequent to the second SPS PDSCH transmission, DCI that schedules a DG PDSCH transmission, where the DCI indicates that the DG PDSCH transmission may be associated with the second HARQ ID, where the DCI includes an indication that the network entity canceled the second SPS PDSCH transmission, and transmitting the DG PDSCH transmission in accordance with the DCI.

Some examples of the method, network entities, and non-transitory computer-readable medium described herein may further include operations, features, means, or instructions for transmitting, to the UE subsequent to the SPS PDSCH transmission, DCI that schedules a DG PDSCH transmission, where the DCI indicates that the DG PDSCH transmission may be associated with the same HARQ ID, and where the DCI includes an indication that the network entity canceled the SPS PDSCH transmission and transmitting, to the UE, the DG PDSCH transmission in accordance with the DCI.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a wireless communications system associated with an example cancelation of a semi-persistent scheduling (SPS) physical downlink shared channel (PDSCH) in accordance with one or more aspects of the present disclosure.

FIG. 2 shows a PDSCH scheduling and timing diagram associated with an example cancelation of an SPS PDSCH in accordance with one or more aspects of the present disclosure.

FIG. 3 shows PDSCH scheduling and timing diagrams associated with examples of cancelation of an SPS PDSCH in accordance with one or more aspects of the present disclosure.

FIG. 4 shows a wireless communications system associated with an example cancelation of an SPS PDSCH in accordance with one or more aspects of the present disclosure.

FIG. 5 shows a PDSCH scheduling and timing diagram associated with an example cancelation of an SPS PDSCH in accordance with one or more aspects of the present disclosure.

FIG. 6 shows a PDSCH scheduling and timing diagram associated with an example cancelation of an SPS PDSCH in accordance with one or more aspects of the present disclosure.

FIG. 7 shows a PDSCH scheduling and timing diagram associated with an example cancelation of an SPS PDSCH in accordance with one or more aspects of the present disclosure.

FIG. 8 shows a PDSCH scheduling and timing diagram associated with an example cancelation of an SPS PDSCH in accordance with one or more aspects of the present disclosure.

FIG. 9 shows a PDSCH scheduling and timing diagram associated with an example cancelation of an SPS PDSCH in accordance with one or more aspects of the present disclosure.

FIG. 10 shows a PDSCH scheduling and timing diagram associated with an example cancelation of an SPS PDSCH in accordance with one or more aspects of the present disclosure.

FIG. 11 shows a process flow associated with an example cancelation of an SPS PDSCH in accordance with one or more aspects of the present disclosure.

FIGS. 12 and 13 show block diagrams of devices associated with examples of cancelation of an SPS PDSCH in accordance with one or more aspects of the present disclosure.

FIG. 14 shows a block diagram of a communications manager associated with an example cancelation of an SPS PDSCH in accordance with one or more aspects of the present disclosure.

FIG. 15 shows a diagram of a system including a device associated with an example cancelation of an SPS PDSCH in accordance with one or more aspects of the present disclosure.

FIGS. 16 and 17 show block diagrams of devices associated with examples of cancelation of an SPS PDSCH in accordance with one or more aspects of the present disclosure.

FIG. 18 shows a block diagram of a communications manager associated with an example cancelation of an SPS PDSCH in accordance with one or more aspects of the present disclosure.

FIG. 19 shows a diagram of a system including a device associated with an example cancelation of an SPS PDSCH in accordance with one or more aspects of the present disclosure.

FIGS. 20 and 21 show flowcharts illustrating methods associated with examples of cancelation of an SPS PDSCH in accordance with one or more aspects of the present disclosure.

### DETAILED DESCRIPTION

Various aspects generally relate to cancelation of semi-persistent scheduling (SPS) physical downlink shared channel (PDSCH) transmissions, and more particularly to cancelation of an SPS PDSCH transmission that follows an unsuccessfully received PDSCH transmission that has the same hybrid automatic repeat request (HARQ) identifier (ID) as the SPS PDSCH. For example, in some aspects, a user equipment (UE) may cancel (for example, may refrain from monitoring for) a scheduled SPS PDSCH transmission that has a same HARQ ID as a PDSCH transmission for which the UE transmitted a negative acknowledgment (NACK). Similarly, in some aspects, a network entity may cancel (for example, may not transmit) a scheduled SPS PDSCH transmission that has a same HARQ ID as a PDSCH transmission for which the network entity received a NACK. In various examples, the negatively acknowledged (NACKed) PDSCH transmission (e.g., the PDSCH transmission for which the UE transmitted a NACK) may be a DG PDSCH transmission or a prior SPS PDSCH transmission. In some aspects, the UE and/or the network entity may implement a timer that begins running at the time of a NACK transmission or reception to avoid cancelation of all SPS PDSCHs having the same HARQ ID as the NACKed PDSCH transmission. For example, by implementing a timer that begins running at the time of a NACK transmission or reception, the UE and the network entity may not cancel SPS PDSCH transmissions with a given HARQ ID for all time, but may cancel SPS PDSCH transmissions during a time in which retransmission is likely. In some aspects, the network may indicate in downlink control information (DCI) that schedules a subsequent dynamic grant (DG) PDSCH transmission whether the network canceled a previous SPS PDSCH transmission.

Particular aspects of the subject matter described in this disclosure may be implemented to realize one or more of the following potential advantages. By refraining from monitoring for a scheduled SPS PDSCH transmission that has a same HARQ ID as a PDSCH for which the UE transmitted a NACK, the UE may refrain from flushing the bits in the HARQ buffer associated with that HARQ ID. The UE may combine those bits in the HARQ buffer with bits from a retransmission of the transport block (TB) of the NACKed PDSCH transmission. The combination of the bits in the HARQ buffer with bits from the retransmission increases the likelihood of successful reception of the TB. By refraining from transmitting (for example, by canceling) a scheduled SPS PDSCH transmission that has a same HARQ ID as a PDSCH transmission for which the network received a NACK, the network entity may save communication resources and/or power by avoiding transmission of a PDSCH transmission for which the UE does not monitor. In some examples, by indicating in a DCI that schedules a subsequent DG PDSCH transmission whether the network canceled a previous SPS PDSCH transmission, the UE may avoid erroneous combinations of buffered data in the case of a of HARQ acknowledgment (ACK) or NACK error.

Aspects of the disclosure are initially described in the context of wireless communications systems. Aspects of the disclosure are further illustrated by and described with reference to PDSCH scheduling and timing diagrams, process flows, apparatus diagrams, system diagrams, and flowcharts that relate to cancelation of an SPS PDSCH.

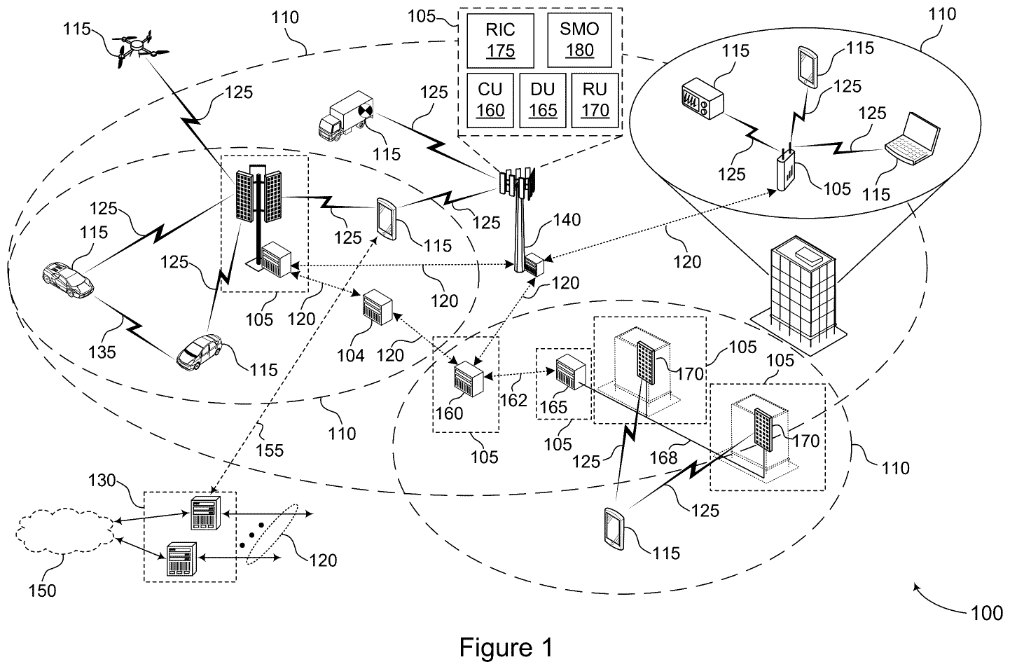

FIG. 1 shows a wireless communications system 100 associated with an example cancelation of an SPS PDSCH in accordance with one or more aspects of the present disclosure. The wireless communications system 100 may include one or more devices, such as one or more network devices (for example, network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (for example, a radio frequency (RF) access link). For example, a network entity 105 may support a coverage area 110 (for example, a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (for example, other wireless communication devices, including UEs 115 or network entities 105), as shown in FIG. 1.

A node of the wireless communications system 100, which may be referred to as a network node, or a wireless node, may be a network entity 105 (for example, any network entity described herein), a UE 115 (for example, any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, among other examples, may include disclosure of the UE 115, network entity 105, apparatus, device, computing system, among other examples, being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (for example, in accordance with an S1, N2, N3, or other interface protocol). In some examples, network entities 105 may communicate with one another via backhaul communication link(s) 120 (for example, in accordance with an X2, Xn, or other interface protocol) either directly (for example, directly between network entities 105) or indirectly (for example, via the core network 130). In some examples, network entities 105 may communicate with one another via a midhaul communication link 162 (for example, in accordance with a midhaul interface protocol) or a fronthaul communication link 168 (for example, in accordance with a fronthaul interface protocol), or any combination thereof. The backhaul communication link(s) 120, midhaul communication links 162, or fronthaul communication links 168 may be or include one or more wired links (for example, an electrical link, an optical fiber link) or one or more wireless links (for example, a radio link, a wireless optical link), among other examples or various combinations thereof. A UE 115 may communicate with the core network 130 via a communication link 155.

One or more of the network entities 105 or network equipment described herein may include or may be referred to as a base station 140 (for example, a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (for example, a base station 140) may be implemented in an aggregated (for example, monolithic, standalone) base station architecture, which may be configured to utilize a protocol stack that is physically or logically integrated within one network entity (for example, a network entity 105 or a single RAN node, such as a base station 140).

In some examples, a network entity 105 may be implemented in a disaggregated architecture (for example, a disaggregated base station architecture, a disaggregated RAN architecture), which may be configured to utilize a protocol stack that is physically or logically distributed among multiple network entities (for example, network entities 105), such as an integrated access and backhaul (IAB) network, an open RAN (O-RAN) (for example, a network configuration sponsored by the O-RAN Alliance), or a virtualized RAN (vRAN) (for example, a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (for example, a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (for example, separate physical locations). In some examples, one or more of the network entities 105 of a disaggregated RAN architecture may be implemented as virtual units (for example, a virtual CU (VCU), a virtual DU (VDU), a virtual RU (VRU)).

The split of functionality between a CU 160, a DU 165, and an RU 170 is flexible and may support different functionalities depending on which functions (for example, network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (for example, layer 3 (L3), layer 2 (L2)) functionality and signaling (for example, Radio Resource Control (RRC), service data adaptation protocol (SDAP), Packet Data Convergence Protocol (PDCP)). The CU 160 (for example, one or more CUs) may be connected to a DU 165 (for example, one or more DUs) or an RU 170 (for example, one or more RUs), or some combination thereof, and the DUs 165, RUs 170, or both may host lower protocol layers, such as layer 1 (L1) (for example, physical (PHY) layer) or L2 (for example, radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (for example, via one or multiple different RUs, such as an RU 170). In some cases, a functional split between a CU 160 and a DU 165 or between a DU 165 and an RU 170 may be within a protocol layer (for example, some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (for example, F1, F1-c, F1-u), and a DU 165 may be connected to an RU 170 via a fronthaul communication link 168 (for example, open fronthaul (FH) interface). In some examples, a midhaul communication link 162 or a fronthaul communication link 168 may be implemented in accordance with an interface (for example, a channel) between layers of a protocol stack supported by respective network entities (for example, one or more of the network entities 105) that are in communication via such communication links.

In some wireless communications systems (for example, the wireless communications system 100), infrastructure and spectral resources for radio access may support wireless backhaul link capabilities to supplement wired backhaul connections, providing an IAB network architecture (for example, to a core network 130). In some cases, in an IAB network, one or more of the network entities 105 (for example, network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (for example, IAB donors) may be in communication with one or more additional devices (for example, IAB node(s) 104) via supported access and backhaul links (for example, backhaul communication link(s) 120). IAB node(s) 104 may include an IAB mobile termination (IAB-MT) controlled (for example, scheduled) by one or more DUs (for example, DUs 165) of a coupled IAB donor. An IAB-MT may be equipped with an independent set of antennas for relay of communications with UEs 115 or may share the same antennas (for example, of an RU 170) of IAB node(s) 104 used for access via the DU 165 of the IAB node(s) 104 (for example, referred to as virtual IAB-MT (vIAB-MT)). In some examples, the IAB node(s) 104 may include one or more DUs (for example, DUs 165) that support communication links with additional entities (for example, IAB node(s) 104, UEs 115) within the relay chain or configuration of the access network (for example, downstream). In such cases, one or more components of the disaggregated RAN architecture (for example, the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support cancelation of an SPS PDSCH transmission that follows an unsuccessfully received PDSCH transmission that has the same hybrid automatic repeat request (HARQ) identifier (ID) as the SPS PDSCH. For example, some operations described as being performed by a UE 115 or a network entity 105 (for example, a base station 140) may additionally, or alternatively, be performed by one or more components of the disaggregated RAN architecture (for example, components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, and the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (for example, one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (for example, a bandwidth part (BWP)) that is operated according to one or more PHY layer channels for a given RAT (for example, LTE, LTE-A, LTE-A Pro, NR). Each PHY layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (for example, entity, sub-entity) of a network entity 105. For example, the terms “transmitting,” “receiving,” or “communicating,” when referring to a network entity 105, may refer to any portion of a network entity 105 (for example, a base station 140, a CU 160, a DU 165, a RU 170) of a RAN communicating with another device (for example, directly or via one or more other network entities, such as one or more of the network entities 105).

The communication link(s) 125 of the wireless communications system 100 may include downlink transmissions (for example, forward link transmissions) from a network entity 105 to a UE 115, uplink transmissions (for example, return link transmissions) from a UE 115 to a network entity 105, or both, among other configurations of transmissions. Carriers may carry downlink or uplink communications (for example, in an FDD mode) or may be configured to carry downlink and uplink communications (for example, in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (for example, 1.4, 3, 5, 10, 15, 20, 40, or 80 megahertz (MHz)). Devices of the wireless communications system 100 (for example, the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (for example, a sub-band, a BWP) or all of a carrier bandwidth.

Signal waveforms transmitted via a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (for example, a duration of one modulation symbol) and one subcarrier, in which case the symbol period and subcarrier spacing may be inversely related. The quantity of bits carried by each resource element may depend on the modulation scheme (for example, the order of the modulation scheme, the coding rate of the modulation scheme, or both), such that a relatively higher quantity of resource elements (for example, in a transmission duration) and a relatively higher order of a modulation scheme may correspond to a relatively higher rate of communication. A wireless communications resource may refer to a combination of an RF spectrum resource, a time resource, and a spatial resource (for example, a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively-numbered subframes or slots, and each subframe or slot may have the same duration. In some examples, a frame may be divided (for example, in the time domain) into subframes, and each subframe may be further divided into a quantity of slots. Alternatively, each frame may include a variable quantity of slots, and the quantity of slots may depend on subcarrier spacing. Each slot may include a quantity of symbol periods (for example, depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, a quantity of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a set of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (for example, control channel elements (CCEs)) associated with encoded information for a control information format having a given payload size. Search space sets may include common search space sets configured for sending control information to UEs 115 (for example, one or more UEs) or may include UE-specific search space sets for sending control information to a UE 115 (for example, a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (for example, using a carrier) and may be associated with an identifier for distinguishing neighboring cells (for example, a physical cell identifier (PCID), a virtual cell identifier (VCID)). In some examples, a cell also may refer to a coverage area 110 or a portion of a coverage area 110 (for example, a sector) over which the logical communication entity operates. Such cells may range from smaller areas (for example, a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a network entity 105 operating with lower power (for example, a base station 140 operating with lower power) relative to a macro cell, and a small cell may operate using the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (for example, a base station 140, an RU 170) may be movable and therefore provide communication coverage for a moving coverage area, such as the coverage area 110. In some examples, coverage areas 110 (for example, different coverage areas) associated with different technologies may overlap, but the coverage areas 110 (for example, different coverage areas) may be supported by the same network entity (for example, a network entity 105). In some other examples, overlapping coverage areas, such as a coverage area 110, associated with different technologies may be supported by different network entities (for example, the network entities 105). The wireless communications system 100 may include, for example, a heterogeneous network in which different types of the network entities 105 support communications for coverage areas 110 (for example, different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (for example, one or more of the UEs 115) via a device-to-device (D2D) communication link, such as a D2D communication link 135 (for example, in accordance with a peer-to-peer (P2P), D2D, or sidelink protocol). In some examples, one or more UEs 115 of a group that are performing D2D communications may be within the coverage area 110 of a network entity 105 (for example, a base station 140, an RU 170), which may support aspects of such D2D communications being configured by (for example, scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (for example, base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (for example, less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (for example, LAA). Operations using unlicensed spectrum may include downlink transmissions, uplink transmissions, P2P transmissions, or D2D transmissions, among other examples.

A network entity 105 (for example, a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (for example, a network entity 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (for example, the communication link(s) 125, a D2D communication link 135). HARQ may include a combination of error detection (for example, using a cyclic redundancy check (CRC)), forward error correction (FEC), and retransmission (for example, automatic repeat request (ARQ)). HARQ may improve throughput at the MAC layer in relatively poor radio conditions (for example, low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support SPS PDSCH transmissions and DG PDSCH transmissions. A DCI may activate an SPS configuration, which may indicate periodic time and/or frequency resources for SPS PDSCH transmissions. A set of HARQ IDs may be configured via RRC signaling per SPS configuration. Within an SPS configuration, the HARQ ID may be incremented for each SPS occasion or period based on the slot number of the SPS PDSCH transmission. A UE 115 may expect a new transmission (for example, a new TB) for each SPS PDSCH transmission.

A DG PDSCH transmission may be dynamically scheduled by DCI. The HARQ ID of a DG PDSCH transmission may be indicated by the DCI that schedules the DG PDSCH transmission. DG PDSCH transmissions may include cell radio network temporary identifier (C-RNTI) PDSCH transmissions (also referred to as regular PDSCH transmission) and configured scheduling RNTI (CS-RNTI) PDSCH transmissions. For example, the DCI may have a cyclic redundancy check (CRC) scrambled by either a C-RNTI or a CS-RNTI. A C-RNTI PDSCH refers to a PDSCH transmission scheduled by a DCI with a CRC scrambled by a C-RNTI. Similarly, a CS-RNTI PDSCH refers to a PDSCH transmission scheduled by a DCI with a CRC scrambled by a CS-RNTI. PDSCH transmissions may either be used for an initial transmission of a TB or a retransmission of a TB depending on whether the new data indicator (NDI) is toggled in the DCI. For example, toggling the NDI may refer to changing the value of the NDI with respect to the value of the NDI for the previous PDSCH associated with the same HARQ ID. For a CS-RNTI PDSCH transmission, the NDI is assumed to not be toggled as CS-RNTI schedules a retransmission of an SPS PDSCH transmission. For example, NDI=“1” in the DCI with a CRC scrambled by CS-RNTI may indicate that the scheduled PDSCH transmission is for the retransmission of an SPS PDSCH transmission (for example, the NDI is assumed not to be toggled for a CS-RNTI PDSCH transmission).

In the case in which a PDSCH transmission is unsuccessfully received (for example, the UE 115 transmits a NACK), and that PDSCH transmission is followed by an SPS PDSCH transmission with the same HARQ ID that the network entity 105 cannot cancel (for example, does not have time to cancel), the UE 115 may flush the bits in the HARQ buffer for the prior NACKed PDSCH transmission. The UE 115 may not use those flushed bits to combine with a retransmission of the TB in the NACKed DG PDSCH transmission. In such cases, retransmission may be less successful, leading to increases in delay of successful retransmissions.

In some examples, to avoid flushing of HARQ bits of a NACKed PDSCH transmission, the UE 115 may cancel (for example, may refrain from monitoring for) an SPS PDSCH that follows the NACKed PDSCH transmission in which the SPS PDSCH transmission has the same HARQ ID as the NACKed PDSCH transmission. The NACKed PDSCH transmission may be a DG PDSCH transmission or a prior SPS PDSCH transmission. The UE 115 may refrain from transmitting HARQ feedback for the canceled SPS PDSCH. By canceling an SPS PDSCH with the same HARQ ID as a NACKed PDSCH, the UE 115 refrains from flushing the bits in the HARQ buffer associated with that HARQ ID, which enables the UE 115 to combine those bits with a retransmission of the TB of the NACKed PDSCH transmission. The network entity 105 may similarly cancel (for example, may refrain from transmitting) an SPS PDSCH transmission that follows the NACKed PDSCH transmission in the case that the SPS PDSCH transmission has the same HARQ ID as the NACKed PDSCH transmission.

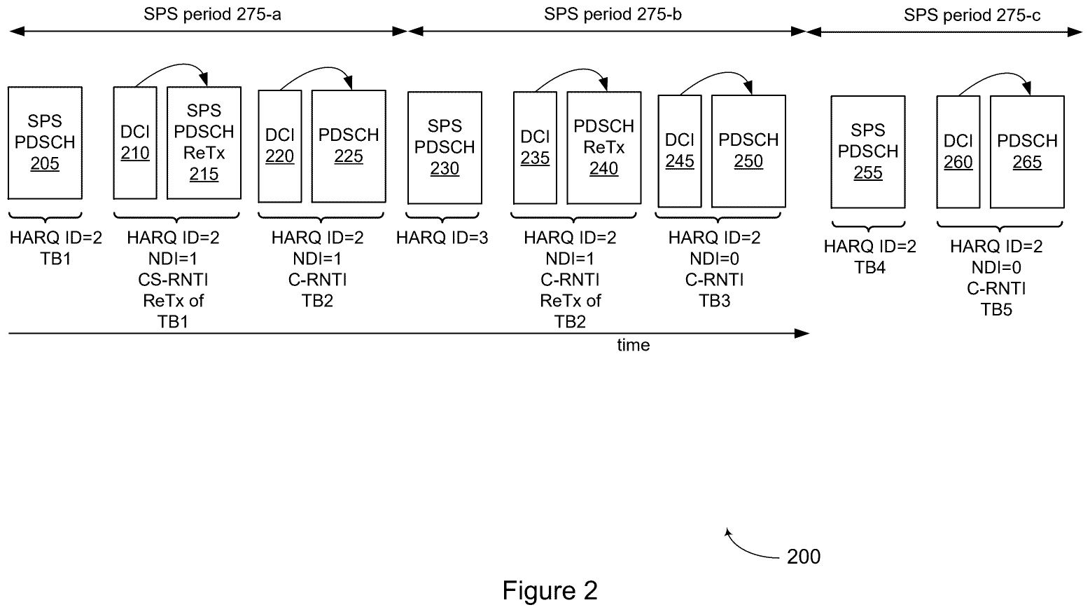

FIG. 2 shows a PDSCH scheduling and timing diagram 200 associated with an example cancelation of an SPS PDSCH in accordance with one or more aspects of the present disclosure. The downlink shared channel scheduling and timing diagram 200 may implement or may be implemented by aspects of the wireless communications system 100. For example, a UE 115 and a network entity 105 as described with reference to FIG. 1 may communicate the transmissions shown in the downlink shared channel scheduling and timing diagram 200.

A set of HARQ IDs may be configured via RRC signaling per SPS configuration. SPS PDSCH transmissions for a UE 115 may be scheduled periodically in accordance with an activated SPS configuration. For example, the SPS PDSCH transmission 205 may be scheduled in the SPS period 275-a, the SPS PDSCH transmission 230 may be scheduled in the SPS period 275-b, and the SPS PDSCH transmission 255 may be scheduled in the SPS period 275-c. The UE 115 may expect a new TB in each SPS PDSCH transmission and a new HARQ ID with respect to the previous SPS PDSCH transmission. For example, the SPS PDSCH transmission 205 may have a HARQ ID of 2 and may convey TB 1, the SPS PDSCH transmission 230 may have a HARQ ID=3, and the SPS PDSCH transmission 255 may have a HARQ ID of 2 and may convey TB 4. For an SPS PDSCH transmission, the UE 115 may assume that the NDI is toggled (for example, changes from the previous value of the NDI) since SPS PDSCH transmissions may correspond to new transmissions and not retransmissions.

For a regular PDSCH transmission (for example, a C-RNTI PDSCH such as the PDSCH transmission 225, the PDSCH transmission 250, and the PDSCH transmission 265), if the previous downlink assignment of the same HARQ ID was either a downlink assignment received for the CS-RNTI of the MAC entity of the UE 115 (for example, was a retransmission of an SPS PDSCH transmission) or a configured downlink assignment (for example, was an SPS PDSCH transmission), the UE 115 may consider the NDI to be toggled regardless of the actual value of the NDI in the scheduling DCI. For example, as shown in FIG. 2, the DCI 210 may schedule the PDSCH transmission 215, which may be a retransmission of TB 1, may be a CS-RNTI PDSCH transmission, may have a HARQ ID=2, and may have an NDI=1. The DCI 220 may schedule the PDSCH transmission 225, which may be a C-RNTI PDSCH, may convey a new TB 2, may have an NDI=1, and may have a HARQ ID=2. The UE 115 may interpret the NDI of the DCI 220 as being toggled based on the CRC of the DCI 220 being scrambled by the C-RNTI even though the NDI=1 in both the DCI 210 and the DCI 220.

The DCI 235 may schedule the PDSCH transmission 240, which may be a retransmission of TB 2. For example, the DCI 235 may indicate that NDI=1 (for example, is not toggled with comparison to the DCI 220) and that the HARQ ID=2. The DCI 235 may include a CRC scrambled by the C-RNTI. As the previous downlink assignment of the same HARQ ID (for example, HARQ ID=2) was a C-RNTI PDSCH transmission (the PDSCH transmission 225), the UE 115 does not interpret the NDI of the DCI 235 that is the same as the NDI of the DCI 220 as being toggled. The UE 115 interprets the PDSCH transmission 240 as conveying a retransmission of the TB 2, which was transmitted in the PDSCH transmission 225. The DCI 245 may schedule the PDSCH transmission 250. The DCI 245 may indicate a HARQ ID=2 and an NDI=0 (for example, toggled with respect to the DCI 235). The DCI 245 may have a CRC scrambled by the C-RNTI. In such cases, the UE 115 may interpret the PDSCH transmission 250 as conveying a new TB 3.

The UE 115 may interpret the SPS PDSCH transmission 255 as conveying a new TB 4 as the UE 115 may assume NDI is toggled for each SPS PDSCH transmission. The SPS PDSCH transmission 255 may have a HARQ ID=2. The DCI 260 may schedule the PDSCH transmission 265. The DCI 260 may indicate a HARQ ID=2 and an NDI=0 (for example, not toggled). The DCI 260 may have a CRC scrambled by the C-RNTI. As the previous downlink assignment associated with the HARQ ID=2 is the SPS PDSCH transmission 255, the UE 115 may interpret the NDI in the DCI 260 as being toggled, and the UE 115 may interpret the PDSCH transmission 265 as conveying a new TB 5.

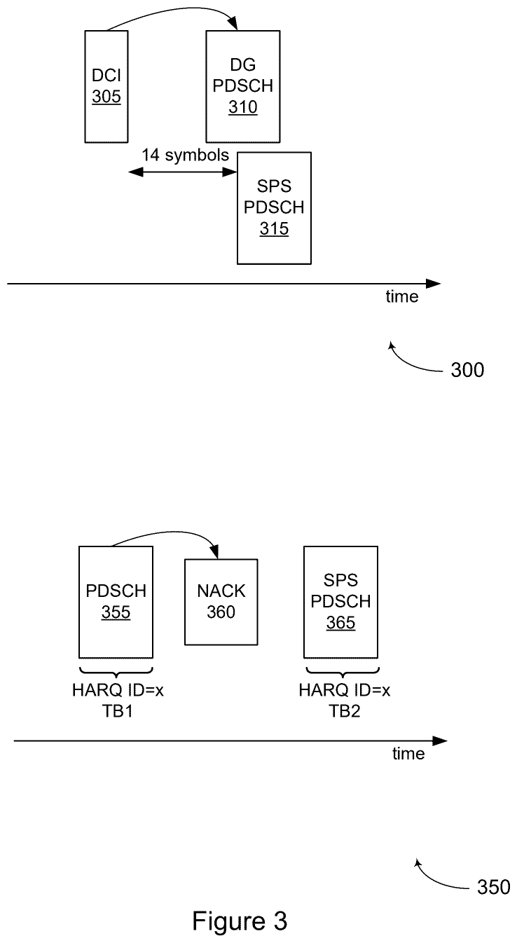

FIG. 3 shows a PDSCH scheduling and timing diagram 300 and a PDSCH scheduling and timing diagram 350 associated with examples of cancelation of an SPS PDSCH in accordance with one or more aspects of the present disclosure. The PDSCH scheduling and timing diagram 300 and the PDSCH scheduling and timing diagram 350 may implement or may be implemented by aspects of the wireless communications system 100. For example, a UE 115 and a network entity 105 as described with reference to FIG. 1 may communicate the transmissions shown in the PDSCH scheduling and timing diagram 300 and the PDSCH scheduling and timing diagram 350.

As shown in the example PDSCH scheduling and timing diagram 300, a DG PDSCH transmission 310 scheduled by a DCI 305 may overlap with an SPS PDSCH transmission 315. If there are less than 14 symbols between the DCI 305 that schedules the DG PDSCH transmission 310 and the SPS PDSCH transmission 315, the UE 115 may consider the DG PDSCH transmission 310 that overlaps with the SPS PDSCH transmission 315 an error case. If there are 14 or more symbols between the DCI 305 that schedules the DG PDSCH transmission 310 and the SPS PDSCH transmission 315, the UE 115 may receive and decode the DG PDSCH transmission 310 and may cancel the SPS PDSCH transmission 315 that overlaps with the DG PDSCH transmission 310 irrespective of the HARQ IDs of the DG PDSCH transmission 310 and the SPS PDSCH transmission 315. A network entity 105 may cancel a scheduled SPS PDSCH transmission by transmitting a DCI at least 14 symbols before the SPS PDSCH transmission that schedules a DG PDSCH transmission that overlaps with the SPS PDSCH transmission. The symbol duration (for example, the 14 symbols) may be based on the smallest numerology between the physical downlink control channel (PDCCH) that conveys the scheduling DCI and the DG PDSCH transmission.

In some examples, as shown in the example PDSCH scheduling and timing diagram 350, an SPS PDSCH transmission 365 may have a same HARQ ID (for example, HARQ ID=x) as a PDSCH transmission 355 that was transmitted earlier (for example, either a previous SPS PDSCH or a previous DG PDSCH) for which the UE 115 transmitted a NACK 360. The network entity 105 may be unable to dynamically control scheduled SPS PDSCH occasions, other than cancelling SPS PDSCH transmissions by transmitting a DCI at least 14 symbols before an SPS PDSCH transmission that schedules DG PDSCH transmission that overlaps in time with the SPS PDSCH transmission. If the network entity 105 does not cancel the SPS PDSCH transmission 365, then HARQ combining for the TB 1 conveyed by the PDSCH transmission 355 may not be realized by the UE 115 as the UE 115 flushes the soft bits in the HARQ buffer after reception of the SPS PDSCH transmission 365. Such a scenario may result in an RLC hole and automatic repeat request (ARQ) retransmission, which may increase latency as the UE 115 is unable to combine the bits received in the PDSCH transmission 355 with a retransmission of the TB 1 as those bits are flushed from the HARQ buffer of the UE 115.

As described with reference to the PDSCH scheduling and timing diagram 300, the network entity 105 may cancel an SPS PDSCH transmission by scheduling an overlapping DG PDSCH transmission via a DCI transmitted at least 14 symbols before the SPS PDSCH transmission. In some cases, however, the network entity 105 may have insufficient time to decode the NACK 360 and transmit a DCI at least 14 symbols before the SPS PDSCH transmission 365. In some cases, the UE 115 may miss the DCI that schedules a DG PDSCH transmission that overlaps with the SPS PDSCH transmission 365, and in such cases, the UE 115 may not cancel the SPS PDSCH transmission 365. In order to cancel the SPS PDSCH transmission 365, the network entity 105 may schedule a DG PDSCH that overlaps with the SPS PDSCH transmission 365, thereby limiting the available time resources for scheduling the DG PDSCH.

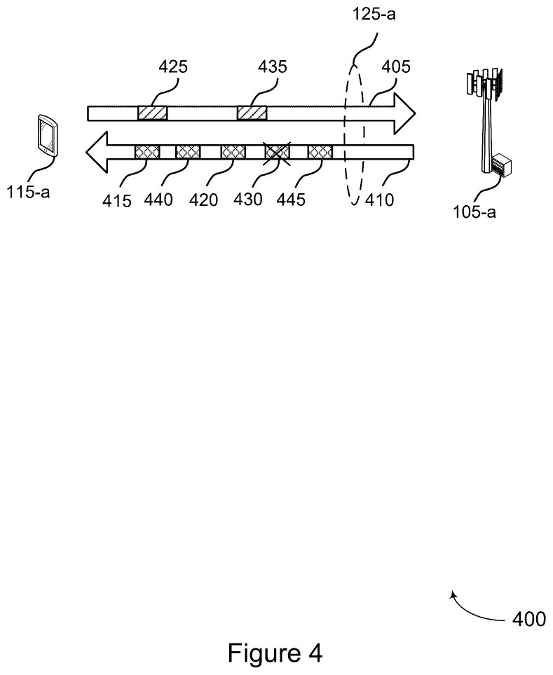

FIG. 4 shows a wireless communications system 400 associated with an example cancelation of an SPS PDSCH in accordance with one or more aspects of the present disclosure. The wireless communications system 400 may implement or may be implemented by aspects of the wireless communications system 100. For example, the wireless communications system 400 includes a UE 115-a and a network entity 105-a, which may be examples of a UE 115 and a network entity 105 described with respect to FIG. 1.

The network entity 105-a may communicate with the UE 115-a via a communication link 125-a, which may be an example of an NR or LTE link between the UE 115-a and the network entity 105-a. In some cases, the communication link 125-a may include an example of an access link (for example, a Uu link). The communication link 125-a may include a bi-directional link that enables both uplink and downlink communication. For example, the UE 115-a may transmit uplink signals 405, such as uplink control signals or uplink data signals, to the network entity 105-a using the communication link 125-a, and the network entity 105-a may transmit downlink signals 410, such as downlink control signals or downlink data signals, to the UE 115-a using the communication link 125-a.

The network entity 105-a may transmit control signaling 415 to the UE 115-a that schedules a set of SPS PDSCH transmissions. For example, the control signaling 415 may be a DCI that activates an RRC configured SPS configuration. The network entity 105-a may transmit a PDSCH transmission 420 to the UE 115-a associated with a first HARQ ID (for example HARQ ID=x). The PDSCH transmission 420 may be a DG PDSCH transmission or an SPS PDSCH transmission. The UE 115-a may not successfully decode the PDSCH transmission 420. The UE 115-a may transmit a NACK 425 to the network entity 105-a indicating that the UE 115-a did not successfully receive the PDSCH transmission 420.

An SPS PDSCH transmission 430 of the set of SPS PDSCH transmissions may be associated with the same HARQ ID (for example, HARQ ID=x) as the PDSCH transmission 420, which the UE 115-a did not successfully receive. In order to avoid flushing the HARQ buffer for the TB conveyed by the PDSCH transmission 420, and to enable the UE 115-a to combine the received bits in the PDSCH transmission 420 with a retransmission of the TB, the UE 115-a may cancel (for example, may refrain from monitoring for) the SPS PDSCH transmission 430. The network entity 105-a may cancel (for example, may refrain from transmitting) the SPS PDSCH transmission 430 based on reception of the NACK 425.

In some examples, cancelation of an SPS PDSCH transmission may be based on detection of a demodulation reference signal (DMRS) in the SPS PDSCH occasion for the SPS PDSCH transmission. For example, prior to attempting to decode an SPS PDSCH transmission, such as the SPS PDSCH transmission 430, the UE 115-a may first detect whether a DMRS is present in the corresponding SPS PDSCH occasion. For example, the network entity 105-a may not successfully receive a NACK or ACK transmitted by the UE 115-a, and/or the UE 115-a may miss a DCI that cancels an SPS PDSCH transmission. In such cases, the UE 115-a may be unaware of whether the network entity 105-a will transmit a given SPS PDSCH transmission. The UE 115-a may perform DMRS detection to determine whether the network entity 105-a will transmit a given SPS PDSCH transmission. For example, the presence of a DMRS in an SPS PDSCH occasion indicates that the network entity 105-a is transmitting an SPS PDSCH transmission in the SPS PDSCH occasion and an absence of a DMRS in an SPS PDSCH occasion indicates that the network entity 105-a is not transmitting an SPS PDSCH transmission in the SPS PDSCH transmission.

For example, the presence of a DMRS in an SPS PDSCH occasion means that the UE 115-a assumes that the NDI is toggled and, and the UE 115-a flushes the HARQ buffer before decoding the corresponding SPS PDSCH transmission and assumes that the SPS PDSCH transmission conveys a new TB. In such cases, the UE 115-a may flush the HARQ buffer for the previous TB associated with the same HARQ ID as the network entity 105-a may not retransmit that TB using the same HARQ ID, as transmission of the SPS PDSCH transmission by the network entity indicates a NACK to ACK error by the network entity 105-a. A NACK to ACK error may refer to a scenario in which the network entity 105-a interprets a NACK transmitted by the UE 115-a as an ACK. In a NACK to ACK error scenario, as the network entity 105-a interprets a prior TB as being successfully received, the network entity 105-a will not retransmit the TB, and the UE 115-a may flush the HARQ buffer. In such scenarios in which the UE detects a DMRS in an SPS PDSCH occasion, which indicates a NACK to ACK error, the UE 115 may transmit a report indicating the NACK to ACK error. For example, the UE 115-a may report that the HARQ ID was unsuccessfully terminated for the previously NACKed TB prior to the SPS PDSCH transmission so that the network entity 105-a may resend the TB via an ARQ mechanism.

As another example, if the UE 115-a does not detect the presence of a DMRS in an SPS PDSCH occasion, the UE 115-a may cancel the SPS PDSCH transmission. In such examples, the UE 115-a may not flush the HARQ buffer for the previous TB associated with the same HARQ ID, and the UE 115-a may determine that the network entity 105-a also canceled the SPS PDSCH transmission. In such examples, network entity 105-a may still send a HARQ retransmission of the previous TB.

For example, the UE 115-a may not detect a DMRS in the SPS PDSCH occasion scheduled for the SPS PDSCH transmission 430, and the UE 115-a may refrain from attempting to decode the SPS PDSCH transmission 430. As another example, the UE 115-a may detect a DMRS in a subsequent SPS PDSCH occasion scheduled for an SPS PDSCH transmission 445, and the UE 115-a may attempt to decode the SPS PDSCH transmission 445 based on detection of the DMRS.

In some examples, the UE 115-a may detect the absence or presence of DMRSs in SPS PDSCH occasions that are expected to be canceled (for example, based on being associated with a same HARQ ID as a previously NACKed PDSCH transmission). For example, the UE 115-a may check for the presence or absence of a DMRS in an SPS PDSCH occasion that is expected to be canceled as an additional condition for canceling the SPS PDSCH transmission in the SPS PDSCH occasion. In some examples, the UE 115-a may rely solely on detection of DRMRs in SPS PDSCH occasions to determine whether the network entity 105-a will transmit an SPS PDSCH transmission in a given SPS PDSCH occasion. Such reliance solely on DMRS detection may be used in conditions when DMRS-based sequence detection is accurate, such as conditions in which the signal to interference and noise ratio (SINR) of the communication link 125-a is high and the resource block allocation for the SPS PDSCH transmission is not narrow (for example, multiple resource blocks are allocated for the SPS PDSCH transmission).

In some examples, the network entity 105-a may transmit second control signaling 440. The second control signaling 440 may indicate a configuration that enables the UE 115-a to cancel SPS PDSCH transmissions that have a same HARQ ID as a prior NACKed PDSCH transmission. In some examples, the configuration may be per HARQ ID, per SPS configuration, per component carrier, or per cell group. In some examples, the UE 115-a may transmit capability signaling 435 indicating that the UE 115-a supports cancelling SPS PDSCH transmissions that have a same HARQ ID as a prior NACKed PDSCH transmission. In such examples, the second control signaling 440 may be based on the capability signaling 435.

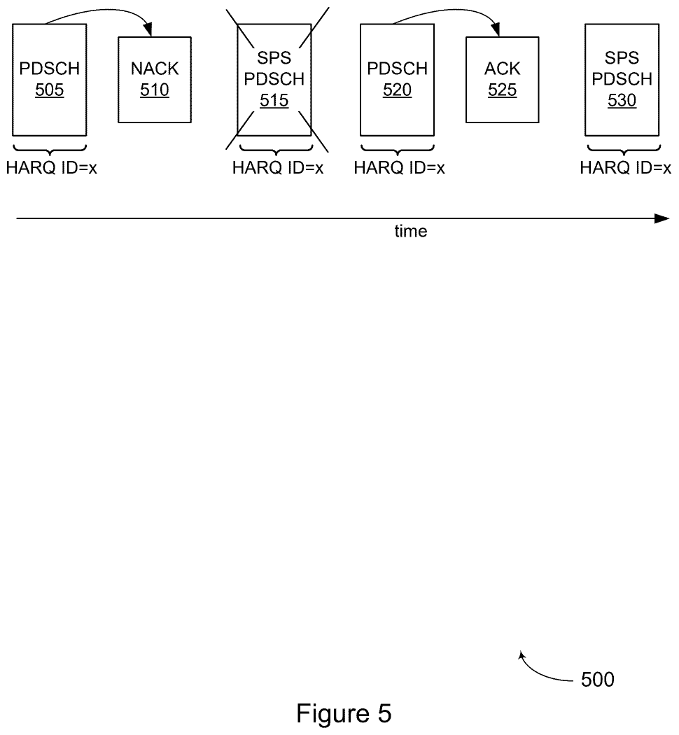

FIG. 5 shows a PDSCH scheduling and timing diagram 500 associated with an example cancelation of an SPS PDSCH in accordance with one or more aspects of the present disclosure. The PDSCH scheduling and timing diagram 500 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 500.

In some examples, a UE 115 may transmit a NACK 510 for a PDSCH transmission 505 associated with a given HARQ ID (for example, the HARQ ID=x). In such examples, the UE 115 may cancel an SPS PDSCH transmission 515 subsequent to the NACK 510 and associated with the same HARQ ID (for example, the HARQ ID=x) to avoid flushing the HARQ buffer for the bits associated with the TB conveyed by the PDSCH transmission 505. Similarly, the network entity 105 may cancel the SPS PDSCH transmission 515 based on reception of the NACK 510 as the UE 115 does not expect the SPS PDSCH transmission 515.

The UE 115 may successfully receive and decode the PDSCH transmission 520, and the UE 115 may transmit an ACK 525 for the PDSCH transmission 520. The PDSCH transmission 520 may be associated with the same HARQ ID (for example, the HARQ ID=x). The UE 115 and the network entity 105 may not cancel the subsequent SPS PDSCH transmission 530, which has the same HARQ ID as the ACK 525 indicates the UE 115 successfully received the PDSCH transmission 520 and flushed the HARQ buffer associated with the HARQ ID.

As shown in FIG. 5, in some examples, the UE 115 may receive an SPS PDSCH transmission only when the previous TB associated with the same HARQ ID is decoded and ACKed by the UE 115. When the SPS PDSCH transmission is canceled, the UE 115 may not transmit HARQ feedback for the canceled SPS PDSCH transmission.

An SPS PDSCH transmission 515 that has the same HARQ ID as a prior NACKed PDSCH transmission may occur for several reasons. A first reason is that the network entity 105 may inaccurately interpret a NACK, such as the NACK 510, as an ACK, which may be referred to as a NACK to ACK error. In such examples, the network entity 105 interprets the UE 115 as successfully receiving and decoding the TB in the PDSCH transmission 505 even though the UE 115 did not successfully receive and decode the TB in the PDSCH transmission 505. In such cases, the network entity 105 would not cancel the SPS PDSCH transmission 515 even if the network entity 105 has sufficient time to cancel the SPS PDSCH transmission 515 (for example, could transmit a DCI at least 14 symbols before the SPS PDSCH transmission 515 in which the DCI schedules a DG PDSCH transmission that overlaps with the SPS PDSCH transmission). A second reason may be that the network entity 105 may give up transmission of the TB in the PDSCH transmission 505. For example, the network entity 105 may reach a threshold quantity of retransmissions of the prior TB or the network entity 105 may receive higher priority traffic to transmit via the SPS PDSCH transmission 515. A third reason may be that the network entity 105 has insufficient time to cancel the SPS PDSCH transmission 515 via transmission of a DCI at least 14 symbols before the SPS PDSCH transmission 515 in which the DCI schedules a DG PDSCH transmission that overlaps with the SPS PDSCH transmission.

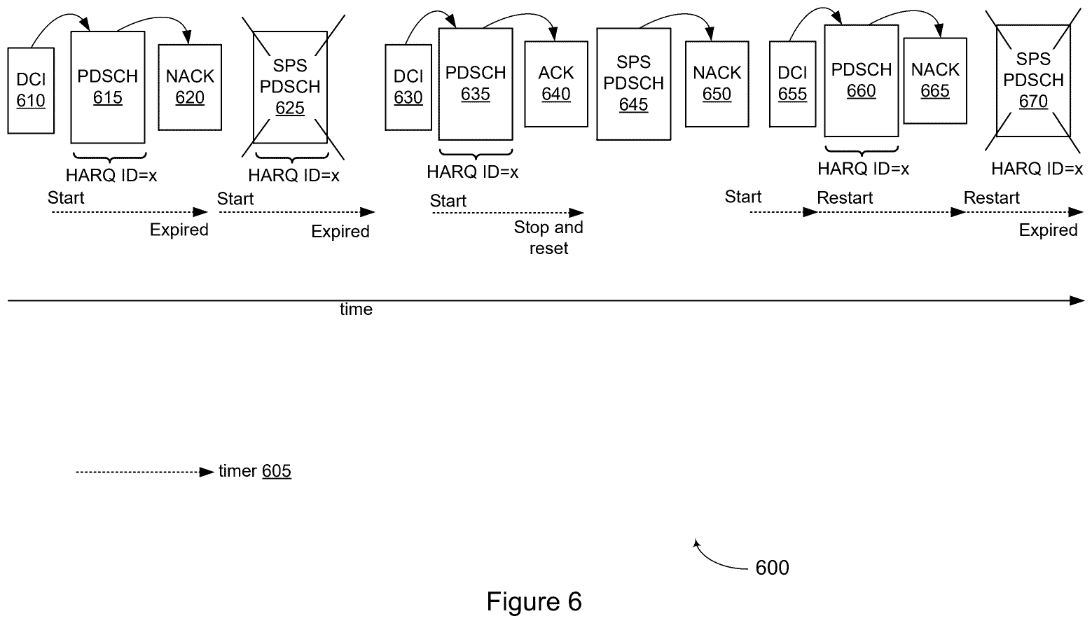

The cancelation of an SPS PDSCH transmission by a UE 115 based on transmitting a NACK for a prior PDSCH transmission that is associated with the same HARQ ID as the canceled SPS PDSCH transmission may resolve the buffer flushing issue associated with the third reason. For the first and second reasons, however, the network entity 105 actually terminates the HARQ retransmission for the TB in the PDSCH transmission 505 (for example, the network entity 105 will not schedule a HARQ retransmission of the TB in the PDSCH transmission 505). A timer mechanism may be used as described with reference to FIG. 6 so that if a HARQ retransmission of a TB, which was NACKed, is not received by the UE 115 within a given duration of time, the UE 115-a may move on without cancelling all subsequent SPS PDSCH transmissions associated with the same HARQ ID.

FIG. 6 shows a PDSCH scheduling and timing diagram 600 associated with an example cancelation of an SPS PDSCH in accordance with one or more aspects of the present disclosure. The PDSCH scheduling and timing diagram 600 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 600.

In some examples, the UE 115 and/or the network entity 105 may implement a timer 605. The UE 115 and/or the network entity 105 may cancel an SPS PDSCH transmission associated with a given HARQ ID if a timer associated with that HARQ ID is running. In some examples, the length (for example, the duration) of the timer 605 may be configured by the network entity 105 (for example, may be indicated to the UE 115 in RRC signaling). The timer 605 may be in ms, a quantity of symbols, or a quantity of slots.

In some examples, the timer 605 may be started or restarted in response to transmission of a NACK for that HARQ ID (for example, from the beginning of the NACK or from the end of the NACK). In some examples, the timer 605 may additionally be started or restarted when a DCI is detected that schedules a PDSCH transmission associated with the same HARQ ID (for example, from the beginning of the DCI or from the end of the DCI). For example, the beginning of the DCI may refer to a first symbol of the DCI, and the end of the DCI may refer to a last symbol of the DCI. In some examples, a timer in response to a DCI detection may be the same timer as the timer 605 that is started or restarted in response to a NACK. In some examples, the timer in response to a DCI detection may be a different timer than the timer 605 that is started or restarted in response to a NACK (for example, the different timer may have a different length, and which may be separately configured, or the different timer may run until the beginning or end of the corresponding HARQ feedback for the scheduled PDSCH transmission). The timer 605 may be stopped and reset in response to transmission of an ACK for that HARQ ID (for example, from the beginning of the ACK or from the end of the ACK). In the case of separate timers in response to the transmission of a NACK and transmission of a DCI, transmission of an ACK may stop both timers. When the timer (for example, at least one timer in the case of separate timers) is running, all SPS PDSCH transmissions associated with the HARQ ID associated with the timer may be canceled. When the timer (or both timers in the case of separate timers) are not running, the SPS PDSCH transmissions associated with the HARQ ID associated with the timer may be received by the UE 115 and/or transmitted by the network entity 105 (for example, the UE 115 and/or the network entity 105 may not cancel SPS PDSCH transmissions associated with a HARQ ID when no timer is running for that HARQ ID).

For example, as shown in FIG. 6, a DCI 610 may schedule a PDSCH transmission 615 with a HARQ ID=x. The timer 605 associated with the HARQ ID=x may be started at the end of the DCI 610 (for example, for the network entity 105 at the end of the transmission of the PDCCH transmission that conveys the DCI 610, and for the UE 115 after completion of reception of the PDCCH transmission that conveys the DCI 610). The UE 115 may not successfully receive the PDSCH transmission 615. The UE 115 may transmit a NACK 620 indicating that the UE 115 did not successfully receive the PDSCH transmission 615. The timer 605 may have a configured duration, and the timer 605 may expire prior to completion of transmission of the NACK 620. The timer 605 may start again after completion of transmission of the NACK 620 for the UE 115 and after completion of reception of the NACK 620 for the network entity 105. The UE 115 and the network entity 105 may cancel the SPS PDSCH transmission 625 that is associated with the HARQ ID=x based on the timer 605 running during the scheduled time resource for the SPS PDSCH transmission 625. The timer 605 may expire after the SPS PDSCH transmission 625 that is canceled.

A DCI 630 may schedule a PDSCH transmission 635 with the HARQ ID=x. The timer 605 associated with the HARQ ID=x may be started at the end of the DCI 630 (for example, for the network entity 105 at the end of the transmission of the PDCCH transmission that conveys the DCI 630, and for the UE 115 after completion of reception of the PDCCH transmission that conveys the DCI 610). The UE 115 may successfully receive the PDSCH transmission 635 and may transmit an ACK 640 for the PDSCH transmission 635. The UE 115 and the network entity 105 may stop and reset the timer 605 based on reception of the ACK 640 associated with the HARQ ID=x.

The network entity 105 may transmit, and the UE 115 may monitor for and attempt to decode, the SPS PDSCH transmission 645 associated with the HARQ ID=x as the timer 605 is not running during the time resource scheduled for the SPS PDSCH transmission 645. Hence, the SPS PDSCH transmission 645 is not canceled as the timer is not running, and UE 115 attempts to decode the SPS PDSCH transmission 645. The UE 115 may not successfully receive the SPS PDSCH transmission 645. The UE 115 may transmit a NACK 650 indicating that the UE 115 did not successfully receive the SPS PDSCH transmission 645. The timer 605 may start again after completion of transmission of the NACK 650 for the UE 115 and after completion of reception of the NACK 650 for the network entity 105.

While the timer 605 is running after the NACK 650, a DCI 655 may schedule a PDSCH transmission 660 with the HARQ ID=x. The timer 605 associated with the HARQ ID=x may be restarted at the end of the DCI 655 (for example, for the network entity 105 at the end of the transmission of the PDCCH transmission that conveys the DCI 655, and for the UE 115 after completion of reception of the PDCCH transmission that conveys the DCI 655). The UE 115 may not successfully receive the PDSCH transmission 660. The UE 115 may transmit a NACK 665 indicating that the UE 115 did not successfully receive the PDSCH transmission 660. The timer 605 may restart after completion of transmission of the NACK 665 for the UE 115 and after completion of reception of the NACK 665 for the network entity 105. The UE 115 and the network entity 105 may cancel the SPS PDSCH transmission 670 that is associated with the HARQ ID=x based on the timer 605 running during the scheduled time resource for the SPS PDSCH transmission 670. The timer 605 may expire after the SPS PDSCH transmission 670.

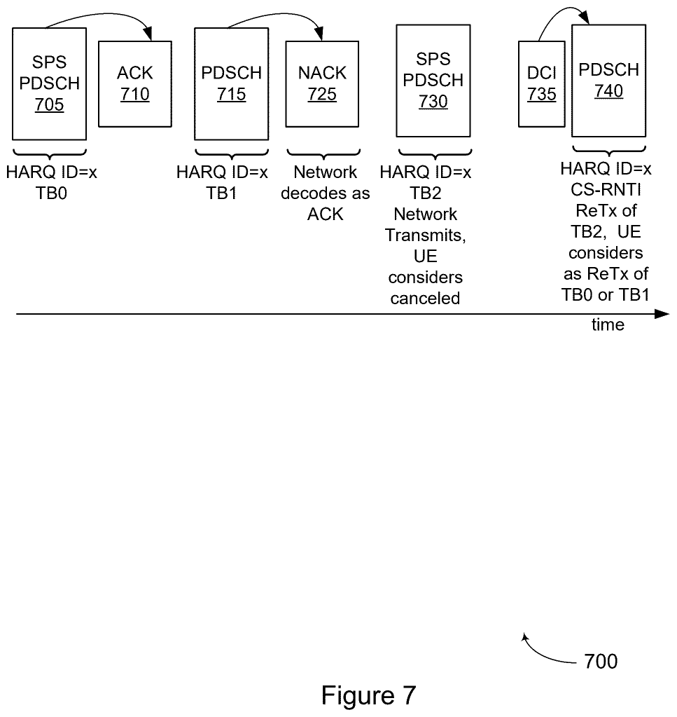

FIG. 7 shows a PDSCH scheduling and timing diagram 700 associated with an example cancelation of an SPS PDSCH in accordance with one or more aspects of the present disclosure. The PDSCH scheduling and timing diagram 700 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 700.

In some examples, a UE 115 may cancel an SPS PDSCH transmission associated with a given HARQ ID based on the running of a timer associated with the given HARQ ID or based on transmission of a NACK associated with the given HARQ ID, but the network entity 105 serving the UE 115 may not cancel the SPS PDSCH transmission and may transmit the SPS PDSCH transmission. For example, this scenario may occur in the case of a NACK to ACK error. The UE 115 may transmit a NACK for a PDSCH transmission associated with the HARQ ID but the network entity 105 may erroneously decode the NACK as an ACK. For example, the network entity 105 may transmit TB 1 in the PDSCH transmission that was NACKed and the network entity 105 may transmit TB 2 in the SPS PDSCH transmission, which the UE 115 interpreted as being canceled. In such examples, the UE 115 does not receive the SPS PDSCH transmission as the UE 115 interprets the SPS PDSCH transmission as being canceled, and the UE 115 does not transmit an ACK or NACK for the SPS PDSCH transmission. After not receiving an ACK or NACK for the SPS transmission, the network entity 105 may schedule a retransmission of TB 2, which the network entity 105 may schedule via a DCI with a CRC scrambled by CS-RNTI and with the same HARQ ID. In such scenarios, the UE 115 may erroneously attempt to recombine the bits from TB 1 in the PDSCH transmission, which was NACKed with the retransmission of the TB 2 if the PDSCH transmission that was NACKed was an SPS PDSCH or was a retransmission of an SPS PDSCH (for example, the PDSCH that was NACKed is associated with CS-RNTI). For example, a DCI with a CRC scrambled by CS-RNTI indicates a retransmission of a TB previously transmitted in an SPS PDSCH transmission. Alternatively, if the PDSCH transmission was not NACKed and a previous SPS PDSCH transmission was ACKed (for example, for TB 0), the UE 115 may discard the retransmission TB 2 as the UE 115 may interpret the retransmission of the TB 2 as being an erroneous retransmission of the ACKed TB 0.

For example, as shown in FIG. 7, the UE 115 may successfully receive an SPS PDSCH transmission 705 conveying TB 0 and associated with HARQ ID=x. The UE 115 may transmit an ACK 710 for the SPS PDSCH transmission 705. The UE 115 may not successfully receive the PDSCH transmission 715 conveying TB 1 and associated with the HARQ ID=x. The UE 115 may transmit a NACK 725 indicating unsuccessful reception of the PDSCH transmission 715. The network entity 105 may interpret the NACK 725 as an ACK. The UE 115 may cancel the SPS PDSCH transmission 730 associated with the HARQ ID=x but the network entity 105 may transmit the SPS PDSCH transmission 730 associated with the HARQ ID=x and conveying the TB 2. The UE 115 may not transmit HARQ feedback for the SPS PDSCH transmission 730 based on canceling the SPS PDSCH transmission 730. The network entity 105 may interpret the lack of HARQ feedback as a NACK for the SPS PDSCH transmission 730, and the network entity 105 may transmit a DCI 735 with a CRC scrambled by CS-RNTI that schedules the PDSCH transmission 740 with a HARQ ID=x for a retransmission of the TB 2. If the PDSCH transmission 715 was an SPS PDSCH transmission or was a retransmission of an SPS PDSCH (associated with CS-RNTI), the UE 115 may interpret the TB in the PDSCH transmission 740 as a retransmission of TB 1, and the UE 115 may erroneously attempt to combine the bits from TB 1 conveyed via the PDSCH transmission 715 with the bits from TB 2 conveyed via the PDSCH transmission 740. If the PDSCH transmission 715 was a DG PDSCH transmission associated with C-RNTI, the UE 115 may interpret the TB in the PDSCH transmission 740 as a retransmission of TB 0, and as the UE 115 transmitted the ACK 710 for the TB 0, the UE 115 may discard the retransmission of the TB 2 in the PDSCH 740 as the UE 115 may erroneously interpret the TB 2 as a retransmission of TB 0. As described, a NACK to ACK error may result in erroneous combinations of TBs or discarding of retransmissions of TBs.

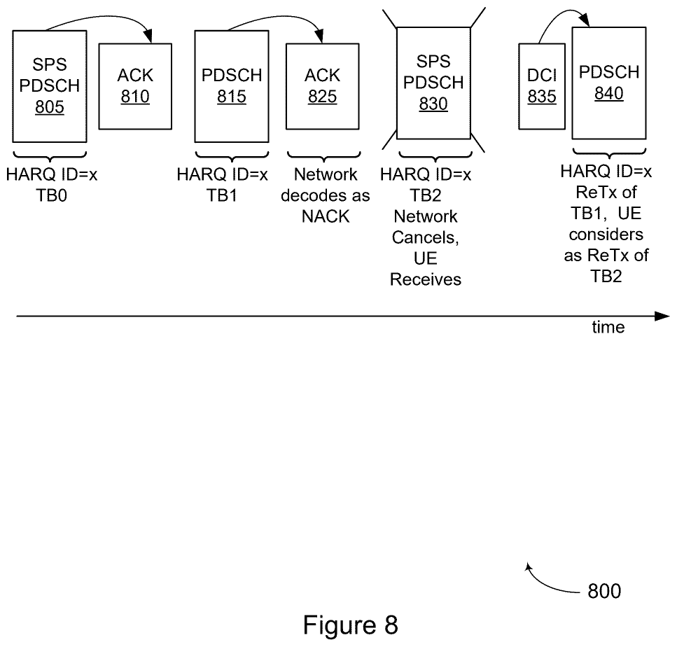

FIG. 8 shows a PDSCH scheduling and timing diagram 800 associated with an example cancelation of an SPS PDSCH in accordance with one or more aspects of the present disclosure. The PDSCH scheduling and timing diagram 800 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 800.

In some examples, a UE 115 may not cancel an SPS PDSCH transmission associated with a given HARQ ID as the UE 115 may have transmitted an ACK for a PDSCH transmission associated with the given HARQ ID, but the network entity 105 serving the UE 115 may cancel the SPS PDSCH transmission based on erroneously misinterpreting the ACK as a NACK. Such an erroneous interpretation of an ACK as a NACK may be referred to as an ACK to NACK error. As another example, the UE 115 may miss a DCI that schedules a new TB after the earlier TB was ACKed and that cancels an SPS PDSCH transmission, which may result in the UE 115 attempting to receive an SPS PDSCH transmission that the network entity 105 canceled. In such examples, if a subsequent PDSCH transmission is scheduled by a DCI with a CRC scrambled by C-RNTI, the UE 115 may assume that the subsequent PDSCH conveys a new TB. If the subsequent PDSCH transmission is scheduled by a DCI with a CRC scrambled by CS-RNTI, the UE 115 may assume that the subsequent PDSCH transmission conveys the same TB as the SPS PDSCH transmission that the network entity 105 canceled, and the UE 115 may attempt to combine the noise received in the SPS PDSCH occasion with the TB received in the subsequent PDSCH transmission, which may lead to decoding errors.

For example, as shown in FIG. 8, the UE may successfully receive an SPS PDSCH transmission 805 conveying TB 0 and associated with HARQ ID=x. The UE 115 may transmit an ACK 810 for the SPS PDSCH transmission 805. The UE 115 may successfully receive the PDSCH transmission 815 conveying TB 1 and associated with the HARQ ID=x. The UE 115 may transmit an ACK 825 indicating successful reception of the PDSCH transmission 815. The network entity 105 may interpret the ACK 825 as a NACK. The network entity 105 may cancel the SPS PDSCH transmission 830 associated with the HARQ ID=x but the UE 115 may not cancel the SPS PDSCH transmission 830 and may monitor the corresponding SPS PDSCH occasion for the SPS PDSCH transmission 830 and may interpret the noise in the channel as a TB 2 associated with HARQ ID=x. In such examples, the UE 115 may transmit a NACK for the SPS PDSCH transmission 830 and may save the soft bits for future soft combining. The network entity 105 subsequently transmit a DCI 835 that schedules a PDSCH transmission 840 associated with HARQ ID=x and that carries a retransmission of TB 1, as the network entity 105 interpreted the ACK 825 as a NACK. If the PDSCH transmission 815 was a DG PDSCH transmission, the DCI 835 has a CRC scrambled by C-RNTI, and the UE 115 interprets the PDSCH transmission 840 as conveying a new TB (given that from the UE point of view, this is the first time that HARQ ID=x after it was last used for the SPS PDSCH transmission 830). If the PDSCH transmission 815 was an SPS PDSCH transmission, the DCI 835 has a CRC scrambled by CS-RNTI, and the UE 115 interprets the PDSCH transmission 840 as conveying a retransmission of the TB 2 of the SPS PDSCH transmission 830. In such examples, the UE 115 may erroneously attempt to combine the TB 1 received in the PDSCH transmission 840 with the noise received in the SPS PDSCH occasion for the SPS PDSCH transmission 830 that was canceled by the network entity 105.

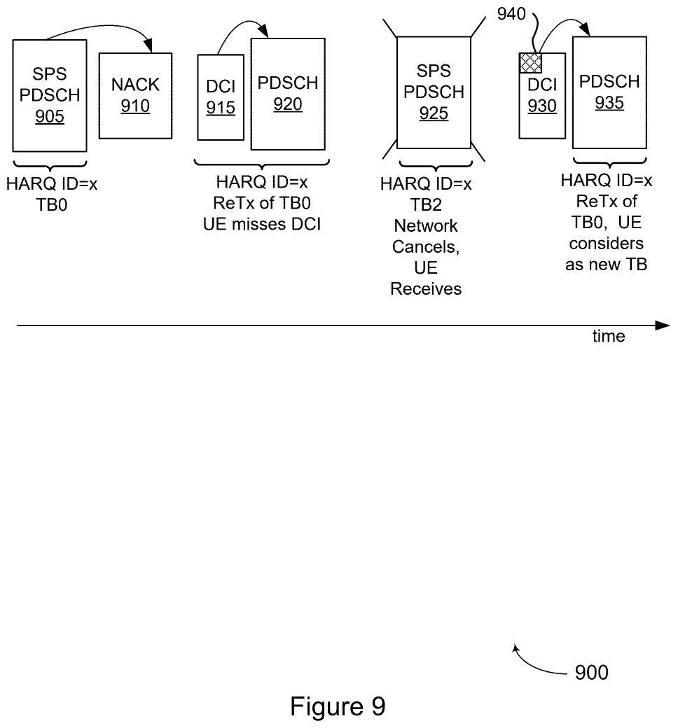

FIG. 9 shows a PDSCH scheduling and timing diagram 900 associated with an example cancelation of an SPS PDSCH in accordance with one or more aspects of the present disclosure. The PDSCH scheduling and timing diagram 900 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 900.

As described with reference to FIG. 7, the UE 115 may cancel an SPS transmission that the network entity 105 does not cancel due to NACK to ACK errors, which may lead to erroneous combining or discarding of TBs. As described with reference to FIG. 8, the network entity 105 may cancel an SPS transmission that the UE 115 does not cancel due to ACK to NACK errors or missed DCIs, which may lead to erroneous combining of TBs. To resolve these issues, the network entity 105 may include an indication in a DCI with a CRC scrambled by CS-RNTI after an SPS PDSCH occasion of whether the network entity 105 canceled the SPS PDSCH transmission in the SPS PDSCH occasion. For example, the indication may be a single bit in DCI. For example, the single bit may reuse an existing field in DCI format 1_1, DCI format 1_0, or DCI format 1_2 (downlink DCI formats or DCI formats capable of scheduling PDSCHs including SPS retransmissions).

For example, in the scenario in which the UE 115 received the SPS PDSCH transmission) and the network entity 105 indicates in the subsequent DCI with a CRC scrambled by CS-RNTI that the network entity 105 transmitted the SPS PDSCH transmission (referred to as scenario 1), the UE 115 may interpret the DCI as scheduling a retransmission of the TB in the SPS PDSCH transmission. In the scenario in which the UE 115 received the SPS PDSCH transmission and the network entity 105 indicates in the subsequent DCI with a CRC scrambled by CS-RNTI that the network entity canceled the SPS PDSCH transmission (referred to as scenario 2), there may be two sub-scenarios. In a first sub-scenario (referred to as scenario 2-1), if the UE 115 already decoded and ACKed the TB associated with the CS-RNTI and the same HARQ-ID (for example, the scenario 2-1 may occur due to an ACK to NACK error), the UE 115 may discard the PDSCH transmission scheduled by the DCI and may transmit an ACK for the PDSCH transmission scheduled by the DCI as the UE already successfully decoded the TB to be delivered by the PDSCH transmission scheduled by the DCI. In a second sub-scenario (referred to as scenario 2-2), if the UE 115 has not already decoded and ACKed the TB associated with the CS-RNTI and the same HARQ-ID (for example, the scenario 2-2 may occur due to a missed DCI), the UE 115 may assume that the NDI is toggled for the DCI and may decode the PDSCH transmission scheduled by the DCI as a new TB (for example, without soft combining the canceled SPS PDSCH transmission). In scenario 2-2, the UE 115 may not perform soft combining as the UE 115 already flushed the HARQ buffer when attempting to receive the canceled SPS PDSCH transmission. However, the UE 115 may avoid attempting to combine the TB with noise from the canceled SPS PDSCH transmission occasion.

For example, the UE 115 may not successfully receive the SPS PDSCH transmission 905 and may transmit a NACK 910 for the SPS PDSCH transmission 905. The SPS PDSCH transmission 905 may convey a TB 0 and may be associated with the HARQ ID=x. The network entity 105 may subsequently transmit a DCI 915 with a CRC scrambled by CS-RNTI that schedules the PDSCH transmission 920. The PDSCH transmission 920 may convey a retransmission of the TB 0 and may be associated with the HARQ ID=x. The UE 115 may miss the DCI 915 and may miss the PDSCH transmission 920. As the UE 115 misses the PDSCH transmission 920, the network entity 105 may cancel the SPS PDSCH transmission 925, but the UE 115 may attempt to receive the SPS PDSCH transmission 925. This can be, for example, due to the timer in response to the NACK 910 for the SPS PDSCH transmission 905 being already expired while the timer is not restarted again as the UE 115 missed the DCI 915 (for example, when the timer associated with a given HARQ ID is not running, the UE 115 may attempt to receive the SPS PDSCH transmission 925 based on the procedures described before). The UE 115 may interpret the SPS PDSCH transmission 925 as conveying a TB 2 and as being associated with the HARQ ID=x.

The network entity 105 may subsequently transmit a DCI 930 with a CRC scrambled by CS-RNTI in order to schedule the PDSCH transmission 935 with HARQ ID=x to convey a retransmission of TB 0. The DCI 930 may include an indication 940 that the network entity 105 canceled the previous SPS PDSCH transmission associated with the HARQ ID=x (the SPS PDSCH transmission 925). Based on the indication 940, the UE 115 may interpret the NDI in the DCI 930 as being toggled, and the UE 115 may decode the PDSCH transmission 935 as conveying a new TB without combining the TB 0 in the PDSCH transmission 935 with the noise interpreted as the TB 2 from the SPS PDSCH transmission 925.

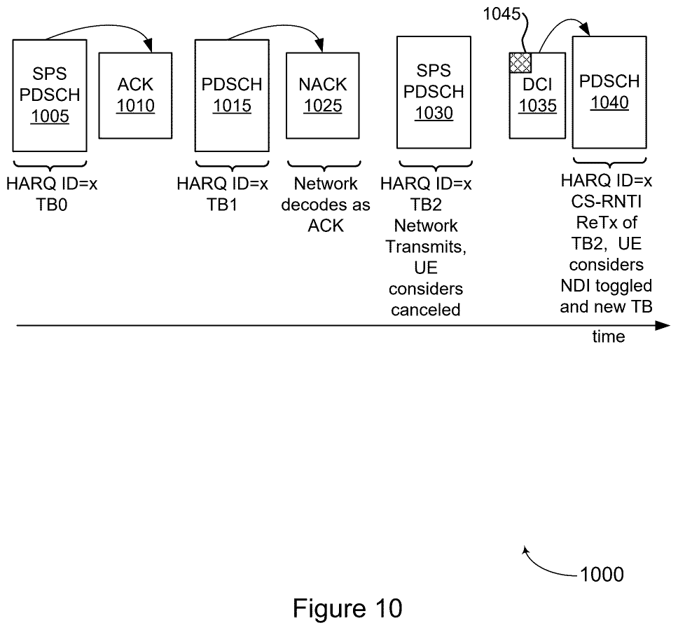

FIG. 10 shows a PDSCH scheduling and timing diagram 1000 associated with an example cancelation of an SPS PDSCH in accordance with one or more aspects of the present disclosure. The PDSCH scheduling and timing diagram 1000 may implement or may be implemented by aspects of the wireless communications system 100 or the wireless communications system 400. For example, a UE 115 and a network entity 105 as described with reference to FIG. 1 may communicate the transmissions shown in the PDSCH scheduling and timing diagram 1000.

As described with reference to FIG. 7, the UE 115 may cancel an SPS transmission that the network entity 105 does not cancel due to NACK to ACK errors, which may lead to erroneous combining or discarding of TBs. As described with reference to FIG. 8, the network entity 105 may cancel an SPS transmission that the UE 115 does not cancel due to ACK to NACK errors or missed DCIs, which may lead to erroneous combining of TBs. To resolve these issues, the network entity 105 may include an indication in a DCI with a CRC scrambled by CS-RNTI after an SPS PDSCH occasion of whether the network entity 105 canceled the SPS PDSCH transmission in the SPS PDSCH occasion. For example, the indication may be a single bit in DCI. For example, the single bit may reuse an existing field in DCI format 1_1, DCI format 1_0, or DCI format 1_2 (downlink DCI formats or DCI formats capable of scheduling PDSCHs including SPS retransmissions).

In the scenario in which the UE 115 did not receive the SPS PDSCH transmission and the network entity 105 indicates in the subsequent DCI with a CRC scrambled by CS-RNTI that the network entity 105 canceled the SPS PDSCH transmission (referred to as scenario 3), there is no issue as both the UE 115 and the network entity 105 interpret the SPS PDSCH as being canceled (and the HARQ buffer is not flushed). In the scenario in which the UE 115 did not receive the SPS PDSCH transmission and the network entity 105 indicates in the subsequent DCI with a CRC scrambled by CS-RNTI that the network entity 105 transmitted the SPS PDSCH transmission (referred to as scenario 4), the UE 115 may assume that the NDI for the subsequent DCI is toggled and may interpret the PDSCH transmission as conveying a new TB. In scenario 4, the UE 115 may flush the HARQ buffer after reception of the subsequent DCI and prior to decoding the scheduled PDSCH transmission.

For example, as shown in FIG. 10, the UE 115 may successfully receive an SPS PDSCH transmission 1005 conveying TB 0 and associated with HARQ ID=x. The UE 115 may transmit an ACK 1010 for the SPS PDSCH transmission 1005. The UE 115 may not successfully receive the PDSCH transmission 1015 conveying TB 1 and associated with the HARQ ID=x. The UE 115 may transmit a NACK 1025 indicating unsuccessful reception of the PDSCH transmission 1015. The network entity 105 may interpret the NACK 1025 as an ACK. The UE 115 may cancel the SPS PDSCH transmission 1030 associated with the HARQ ID=x but the network entity 105 may transmit the SPS PDSCH transmission 1030 associated with the HARQ ID=x and conveying the TB 2. The UE 115 may not transmit HARQ feedback for the SPS PDSCH transmission 1030 based on canceling the SPS PDSCH transmission 1030. The network entity 105 may interpret the lack of HARQ feedback as a NACK for the SPS PDSCH transmission 1030, and the network entity 105 may transmit a DCI 1035 with a CRC scrambled by CS-RNTI that schedules the PDSCH transmission 1040 with a HARQ ID=x for a retransmission of the TB 2. The DCI 1035 may include an indication 1045 that the network entity 105 transmitted the prior SPS PDSCH transmission associated with the HARQ ID=x (the SPS PDSCH transmission 1030). Based on the indication 1045, the UE 115 may interpret the NDI in the DCI 1035 as being toggled and the PDSCH transmission 1040 as conveying a new TB.

If the TB 1 in the PDSCH transmission 1015 is associated with a CS-RNTI, the UE 115 does not wrongly assume that the PDSCH transmission 1040 is a retransmission of TB 1 and avoids erroneously soft combining the PDSCH transmission 1040 with the PDSCH transmission 1015. If the TB 1 in the PDSCH transmission 1015 is associated with a C-RNTI, the UE 115 does not wrongly assume that the PDSCH transmission 1040 is a retransmission of TB 0 and avoids erroneously discarding the TB in the PDSCH transmission 1040. In some examples, the UE 115 may report to the network entity 105 that there is an unsuccessful HARQ termination event corresponding to TB 1 (which is due to a NACK to ACK error). Such UE reporting may be an additional benefit of (and in response to) the indication 1045. In such examples, the network entity 105 may retransmit the TB 1 (for example, via an ARQ mechanism).

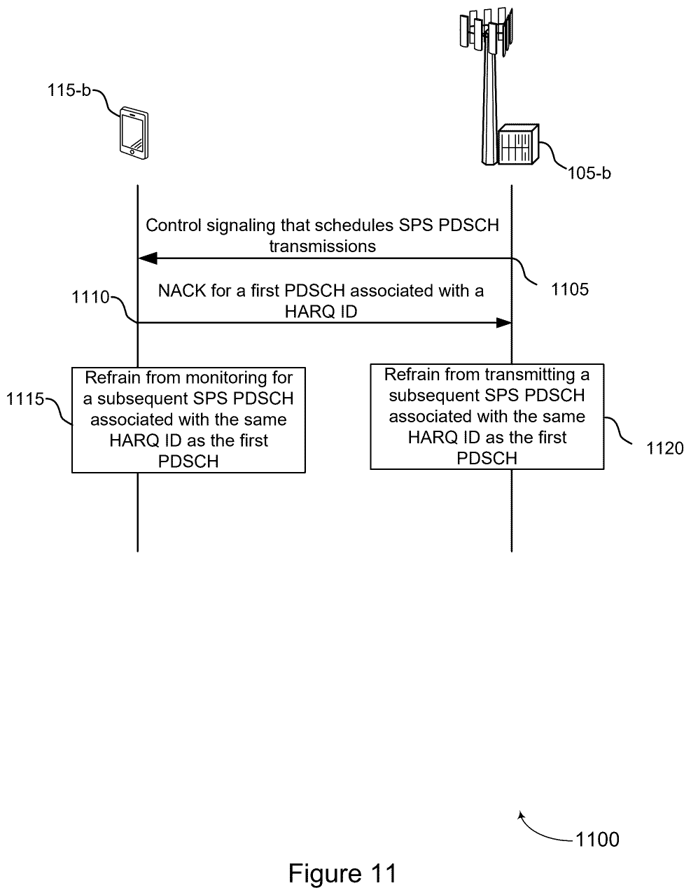

FIG. 11 shows a process flow 1100 associated with an example cancelation of an SPS PDSCH in accordance with one or more aspects of the present disclosure. The process flow 1100 may include a UE 115-b and a network entity 105-b, which may be examples of a UE 115 and a network entity 105. In the following description of the process flow 1100, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 1100, and other operations may be added to the process flow 1100.

At 1105, the network entity 105-b may transmit, to the UE 115-b, control signaling that schedules a set of SPS PDSCH transmissions.

At 1110, the UE 115-b may transmit, to the network entity 105-b, a NACK for a first PDSCH transmission, the first PDSCH transmission associated with a first HARQ ID.

At 1115, the UE 115-b may refrain from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH.

At 1120, the network entity 105-b may refrain from transmitting, subsequent to and in accordance with reception of the NACK, for an SPS PDSCH transmission of the set of SPS PDSCH transmissions in accordance with the SPS PDSCH transmission being associated with the same HARQ ID as the first PDSCH.

In some examples, the UE 115-b may start a timer in accordance with transmission of the NACK, and refraining from monitoring for the SPS PDSCH transmission is associated with the SPS PDSCH transmission being scheduled in a duration after starting the timer and before an expiration of the timer. Similarly, in some examples, the network entity 105-b may start a timer in accordance with reception of the NACK, and refraining from transmitting the SPS PDSCH transmission is associated with the SPS PDSCH transmission being scheduled in a duration after starting the timer and before an expiration of the timer. In some examples, the network entity 105-b may transmit to the UE 115-b, after the expiration of the timer, a second SPS PDSCH transmission of the set of SPS PDSCH transmissions, and the second SPS PDSCH transmission is associated with the same HARQ ID. In some examples, the network entity 105-b may transmit to the UE 115-b, DCI that schedules a DG PDSCH transmission, and the DG PDSCH transmission is associated with the same HARQ ID. The UE 115-b and the network entity 105-b may start or restart the timer in association with transmission of the DCI that schedules the DG PDSCH transmission associated with the same HARQ ID. In some examples, the UE 115-b may transmit, to the network entity 105-b, an ACK for a second PDSCH transmission, and the second PDSCH transmission is associated with the same HARQ ID. In such examples, the UE 115-b and the network entity 105-b may terminate the timer in association with transmission and reception of the ACK, respectively. In such examples, the network entity 105-b may transmit, to the UE 115-b after termination of the timer, a second SPS PDSCH transmission of the set of SPS PDSCH transmissions. The second SPS PDSCH transmission may be associated with the same HARQ ID. In some examples, the network entity 105-b may transmit, to the UE 115-b, second control signaling that indicates the duration associated with the timer.

In some examples, the UE 115-b may receive, from the network entity 105-b, a second SPS PDSCH transmission of the set of SPS PDSCH transmissions. The second SPS PDSCH transmission may be associated with a second HARQ ID. The UE 115-b may transmit, to the network entity 105-b, a first ACK for the second SPS PDSCH transmission. The UE 115-b may receive, from the network entity 105-b and subsequent to the second SPS PDSCH transmission, DCI that schedules a DG PDSCH transmission. The DCI may indicate that the DG PDSCH transmission is associated with the second HARQ ID, and the DCI may include an indication that the network entity 105-b canceled the second SPS PDSCH transmission. The UE 115-b may transmit, in association with the DG PDSCH transmission being associated with the same HARQ ID and in association with the transmission of the first ACK, a second ACK for the DG PDSCH transmission.

In some examples, the UE 115-b may receive, from the network entity 105-b, a second PDSCH transmission associated with a second HARQ ID. The UE 115-b may transmit, to the network entity 105-b, a second NACK for the second PDSCH transmission. The UE 115-b may receive, from the network entity 105-b subsequent to transmitting the second NACK, a second SPS PDSCH transmission of the set of SPS PDSCH transmissions. The second SPS PDSCH transmission may be associated with the second HARQ ID. The UE 115-b may receive, from the network entity 105-b subsequent to the second SPS PDSCH transmission, DCI that schedules a DG PDSCH transmission. The DCI may indicate that the DG PDSCH transmission is associated with the second HARQ ID, and the DCI may include an indication that the network entity 105-b canceled the second SPS PDSCH transmission. The UE 115-b may receive the DG PDSCH transmission from the network entity 105-b in accordance with the DCI and in accordance with an interpretation that an NDI associated with the second HARQ ID is toggled (for example, that the DG PDSCH includes new data). The interpretation may be in association with transmission of the second NACK and the indication that the network entity 105-b canceled the second SPS PDSCH transmission.

In some examples, the UE 115-b may receive, from the network entity 105-b and subsequent to the SPS PDSCH transmission, DCI that schedules a DG PDSCH transmission. The DCI may indicate that the DG PDSCH transmission is associated with the same HARQ ID, and the DCI may include an indication that the network entity 105-b canceled the SPS PDSCH transmission. The UE 115-b may receive the DG PDSCH transmission from the network entity 105-b in accordance with the DCI and in accordance with an interpretation that an NDI associated with the same HARQ ID is not toggled (for example, that the DG PDSCH includes retransmitted data). The interpretation may be in accordance with the transmission of the NACK and the indication that the network entity 105-b canceled the SPS PDSCH transmission.

In some examples, the UE 115-b may receive, from the network entity 105-b and subsequent to the SPS PDSCH transmission, DCI that schedules a DG PDSCH transmission. The DCI may indicate that the DG PDSCH transmission is associated with the same HARQ ID, and the DCI may include an indication that the network entity 105-b transmitted the SPS PDSCH transmission. The UE 115-b may receive the DG PDSCH transmission from the network entity 105-b in accordance with the DCI and in accordance with an interpretation that an NDI associated with the same HARQ ID is toggled. The interpretation may be in accordance with the indication that the network entity 105-b transmitted the SPS PDSCH transmission. In some examples, the UE 115-b may transmit, to the network entity 105-b in association with the indication that the network entity 105-b transmitted the SPS PDSCH transmission and subsequent to and in accordance with reception of the DCI, a message indicating that the UE 115-b transmitted the NACK.

In some examples, the UE 115-b may detect an absence of a DMRS in a resource of the SPS PDSCH transmission, and refraining from monitoring for the SPS PDSCH transmission at 1115 is further in association with detecting the absence of the DMRS.

In some examples, the network entity 105-b may transmit, to the UE 115-b, second control signaling that indicates a configuration to refrain from monitoring for one or more SPS PDSCH transmissions associated with a NACKed HARQ ID (e.g., a NACK transmitted by the UE 115-b may indicate the HARQ ID of the corresponding PDSCH transmission which the UE 115-b did not successfully receive and accordingly NACKed).

In some examples, the UE 115-b may transmit, to the network entity 105-b, capability signaling indicating a capability of the UE 115-b to support a configuration to refrain from monitoring for one or more SPS PDSCH transmissions associated with a NACKed HARQ ID.

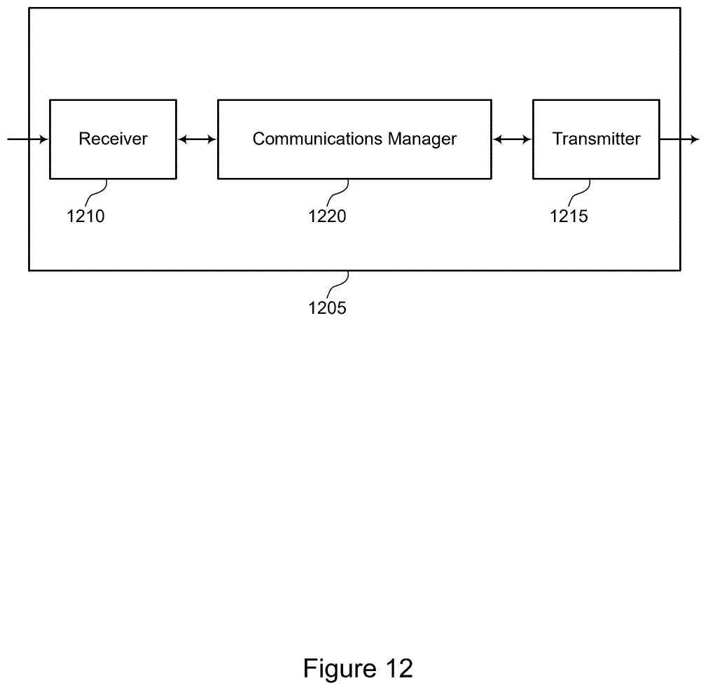

FIG. 12 shows a block diagram of a device 1205 associated with an example cancelation of an SPS PDSCH in accordance with one or more aspects of the present disclosure. The device 1205 may be an example of aspects of a UE 115. The device 1205 may include a receiver 1210, a transmitter 1215, and a communications manager 1220. The device 1205, or one or more components of the device 1205 (for example, the receiver 1210, the transmitter 1215, the communications manager 1220), may include at least one processor, which may be coupled with at least one memory, to, individually or collectively, support or enable the described techniques. Each of these components may be in communication with one another (for example, via one or more buses). The communications manager 1220 can be implemented, at least in part, by one or both of a modem and a processor.

The receiver 1210 may provide a means for receiving information such as packets, user data, control information, or any combination thereof associated with various information channels (for example, control channels, data channels, information channels related to cancelation of SPS PDSCH). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (for example, control channels, data channels, information channels related to cancelation of SPS PDSCH). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of cancelation of SPS PDSCH. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (for example, in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 1220 may be configured to perform various operations (for example, receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations.

The communications manager 1220 may support wireless communication in accordance with examples as disclosed herein. For example, the communications manager 1220 is capable of, configured to, or operable to support a means for receiving control signaling that schedules a set of SPS PDSCH transmissions. The communications manager 1220 is capable of, configured to, or operable to support a means for transmitting a NACK for a first PDSCH transmission, the first PDSCH transmission associated with a HARQ ID. The communications manager 1220 is capable of, configured to, or operable to support a means for refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

By including or configuring the communications manager 1220 in accordance with described examples, the device 1205 (for example, at least one processor controlling or otherwise coupled with the receiver 1210, the transmitter 1215, the communications manager 1220, or a combination thereof) may support techniques for reduced power consumption and more efficient utilization of communication resources.

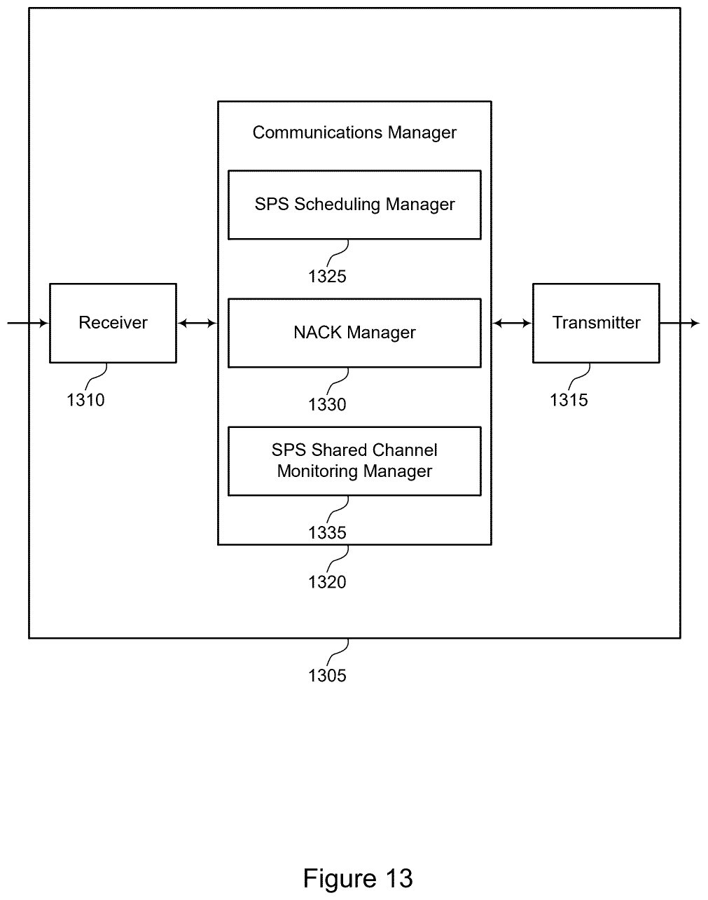

FIG. 13 shows a block diagram of a device 1305 associated with an example cancelation of an SPS PDSCH in accordance with one or more aspects of the present disclosure. The device 1305 may be an example of aspects of a device 1205 or a UE 115. The device 1305 may include a receiver 1310, a transmitter 1315, and a communications manager 1320. The device 1305, or one or more components of the device 1305 (for example, the receiver 1310, the transmitter 1315, the communications manager 1320), may include at least one processor, which may be coupled with at least one memory, to support the described techniques. Each of these components may be in communication with one another (for example, via one or more buses). The communications manager 1320 can be implemented, at least in part, by one or both of a modem and a processor.

The receiver 1310 may provide a means for receiving information such as packets, user data, control information, or any combination thereof associated with various information channels (for example, control channels, data channels, information channels related to cancelation of SPS PDSCH). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (for example, control channels, data channels, information channels related to cancelation of SPS PDSCH). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of cancelation of SPS PDSCH. For example, the communications manager 1320 may include an SPS scheduling manager 1325, a NACK manager 1330, an SPS shared channel monitoring manager 1335, or any combination thereof. The communications manager 1320 may be an example of aspects of a communications manager 1220. In some examples, the communications manager 1320, or various components thereof, may be configured to perform various operations (for example, receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations.

The communications manager 1320 may support wireless communication in accordance with examples as disclosed herein. The SPS scheduling manager 1325 is capable of, configured to, or operable to support a means for receiving control signaling that schedules a set of SPS PDSCH transmissions. The NACK manager 1330 is capable of, configured to, or operable to support a means for transmitting a NACK for a first PDSCH transmission, the first PDSCH transmission associated with a HARQ ID. The SPS shared channel monitoring manager 1335 is capable of, configured to, or operable to support a means for refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

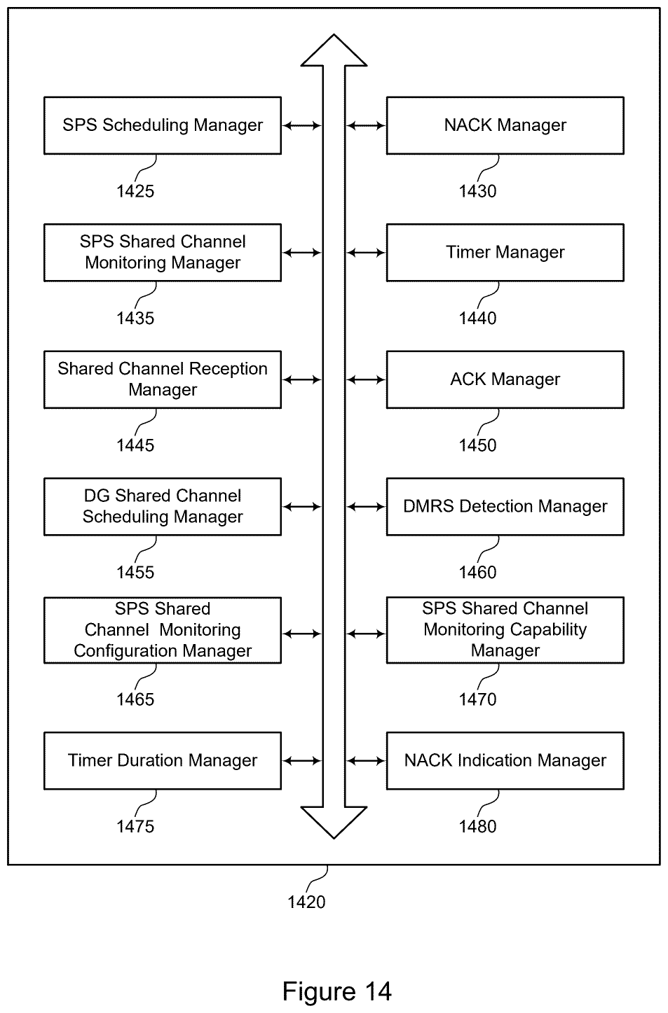

FIG. 14 shows a block diagram of a communications manager 1420 associated with an example cancelation of an SPS PDSCH in accordance with one or more aspects of the present disclosure. The communications manager 1420, or various components thereof, may be an example of means for performing various aspects of cancelation of SPS PDSCH. For example, the communications manager 1420 may include an SPS scheduling manager 1425, a NACK manager 1430, an SPS shared channel monitoring manager 1435, a timer manager 1440, a shared channel reception manager 1445, an ACK manager 1450, a DG shared channel scheduling manager 1455, a DMRS detection manager 1460, an SPS shared channel monitoring configuration manager 1465, an SPS shared channel monitoring capability manager 1470, a timer duration manager 1475, a NACK indication manager 1480, or any combination thereof. Each of these components, or components or subcomponents thereof (for example, one or more processors, one or more memories), may communicate, directly or indirectly, with one another (for example, via one or more buses).

The communications manager 1420 may support wireless communication in accordance with examples as disclosed herein. The SPS scheduling manager 1425 is capable of, configured to, or operable to support a means for receiving control signaling that schedules a set of SPS PDSCH transmissions. The NACK manager 1430 is capable of, configured to, or operable to support a means for transmitting a NACK for a first PDSCH transmission, the first PDSCH transmission associated with a HARQ ID. The SPS shared channel monitoring manager 1435 is capable of, configured to, or operable to support a means for refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

In some examples, the timer manager 1440 is capable of, configured to, or operable to support a means for starting a timer in accordance with transmission of the NACK. Refraining from monitoring for the SPS PDSCH transmission may be associated with the SPS PDSCH transmission being scheduled in a duration after starting the timer and before an expiration of the timer.

In some examples, the shared channel reception manager 1445 is capable of, configured to, or operable to support a means for monitoring for, after the expiration of the timer, a second SPS PDSCH transmission of the set of SPS PDSCH transmissions. The second SPS PDSCH transmission may be associated with the same HARQ ID.

In some examples, the DG shared channel scheduling manager 1455 is capable of, configured to, or operable to support a means for receiving, DCI that schedules a DG PDSCH transmission. The DG PDSCH transmission may be associated with the same HARQ ID. In some examples, the timer manager 1440 is capable of, configured to, or operable to support a means for starting or restarting the timer in association with reception of the DCI that schedules the DG PDSCH transmission associated with the same HARQ ID.

In some examples, the ACK manager 1450 is capable of, configured to, or operable to support a means for transmitting an ACK for a second PDSCH transmission. The second PDSCH transmission may be associated with the same HARQ ID. In some examples, the timer manager 1440 is capable of, configured to, or operable to support a means for terminating the timer in association with transmission of the ACK. In some examples, the shared channel reception manager 1445 is capable of, configured to, or operable to support a means for monitoring for, after termination of the timer, a second SPS PDSCH transmission of the set of SPS PDSCH transmissions. The second SPS PDSCH transmission may be associated with the same HARQ ID.

In some examples, the timer duration manager 1475 is capable of, configured to, or operable to support a means for receiving second control signaling that indicates the duration associated with the timer.

In some examples, the shared channel reception manager 1445 is capable of, configured to, or operable to support a means for monitoring for a second SPS PDSCH transmission of the set of SPS PDSCH transmissions. The second SPS PDSCH transmission may be associated with a second HARQ ID. In some examples, the ACK manager 1450 is capable of, configured to, or operable to support a means for transmitting a first ACK for the second SPS PDSCH transmission. In some examples, the DG shared channel scheduling manager 1455 is capable of, configured to, or operable to support a means for receiving, from a network entity and subsequent to the second SPS PDSCH transmission, DCI that schedules a DG PDSCH transmission. The DCI may indicate that the DG PDSCH transmission is associated with the second HARQ ID. The DCI may include an indication that the network entity canceled the second SPS PDSCH transmission. In some examples, the ACK manager 1450 is capable of, configured to, or operable to support a means for transmitting, in association with the DG PDSCH transmission being associated with the same HARQ ID and in association with the transmission of the first ACK, a second ACK for the DG PDSCH transmission.

In some examples, the shared channel reception manager 1445 is capable of, configured to, or operable to support a means for monitoring for a second PDSCH transmission associated with a second HARQ ID. In some examples, the NACK manager 1430 is capable of, configured to, or operable to support a means for transmitting a second NACK for the second PDSCH transmission. In some examples, the shared channel reception manager 1445 is capable of, configured to, or operable to support a means for monitoring for, subsequent to transmitting the second NACK, a second SPS PDSCH transmission of the set of SPS PDSCH transmissions. The second SPS PDSCH transmission may be associated with the second HARQ ID. In some examples, the DG shared channel scheduling manager 1455 is capable of, configured to, or operable to support a means for receiving, from a network entity and subsequent to the second SPS PDSCH transmission, DCI that schedules a DG PDSCH transmission. The DCI may indicate that the DG PDSCH transmission is associated with the second HARQ ID. The DCI may include an indication that the network entity canceled the second SPS PDSCH transmission. In some examples, the shared channel reception manager 1445 is capable of, configured to, or operable to support a means for monitoring for the DG PDSCH transmission in accordance with the DCI and in accordance with an interpretation that an NDI associated with the second HARQ ID indicates that the DG PDSCH transmission includes new data. The interpretation may be in association with transmission of the second NACK and the indication that the network entity canceled the second SPS PDSCH transmission.

In some examples, the DG shared channel scheduling manager 1455 is capable of, configured to, or operable to support a means for receiving, from a network entity and subsequent to the SPS PDSCH transmission, DCI that schedules a DG PDSCH transmission. The DCI may indicate that the DG PDSCH transmission is associated with the same HARQ ID. The DCI may include an indication that the network entity canceled the SPS PDSCH transmission. In some examples, the shared channel reception manager 1445 is capable of, configured to, or operable to support a means for monitoring for the DG PDSCH transmission in accordance with the DCI and in accordance with an interpretation that an NDI associated with the same HARQ ID indicates that the DG PDSCH transmission includes retransmitted data. The interpretation may be in accordance with the transmission of the NACK and the indication that the network entity canceled the SPS PDSCH transmission.

In some examples, the DG shared channel scheduling manager 1455 is capable of, configured to, or operable to support a means for receiving, from a network entity and subsequent to the SPS PDSCH transmission, DCI that schedules a DG PDSCH transmission. The DCI may indicate that the DG PDSCH transmission is associated with the same HARQ ID. The DCI may include an indication that the network entity transmitted the SPS PDSCH transmission. In some examples, the shared channel reception manager 1445 is capable of, configured to, or operable to support a means for monitoring for the DG PDSCH transmission in accordance with the DCI and in accordance with an interpretation that an NDI associated with the same HARQ ID indicates that the DG PDSCH transmission includes new data. The interpretation may be in accordance with the indication that the network entity transmitted the SPS PDSCH transmission.

In some examples, the NACK indication manager 1480 is capable of, configured to, or operable to support a means for transmitting, to the network entity in association with the indication that the network entity transmitted the SPS PDSCH transmission and subsequent to and in accordance with reception of the DCI, a message indicating that the UE transmitted the NACK.

In some examples, the DMRS detection manager 1460 is capable of, configured to, or operable to support a means for detecting an absence of a DMRS in a resource of the SPS PDSCH transmission. Refraining from monitoring for the SPS PDSCH transmission may be further in association with detecting the absence of the DMRS.

In some examples, the SPS shared channel monitoring configuration manager 1465 is capable of, configured to, or operable to support a means for receiving second control signaling that indicates a configuration to refrain from monitoring for one or more SPS PDSCH transmissions associated with a NACKed HARQ ID.

In some examples, the SPS shared channel monitoring capability manager 1470 is capable of, configured to, or operable to support a means for transmitting capability signaling indicating a capability of the UE to support a configuration to refrain from monitoring for one or more SPS PDSCH transmissions associated with a NACKed HARQ ID.

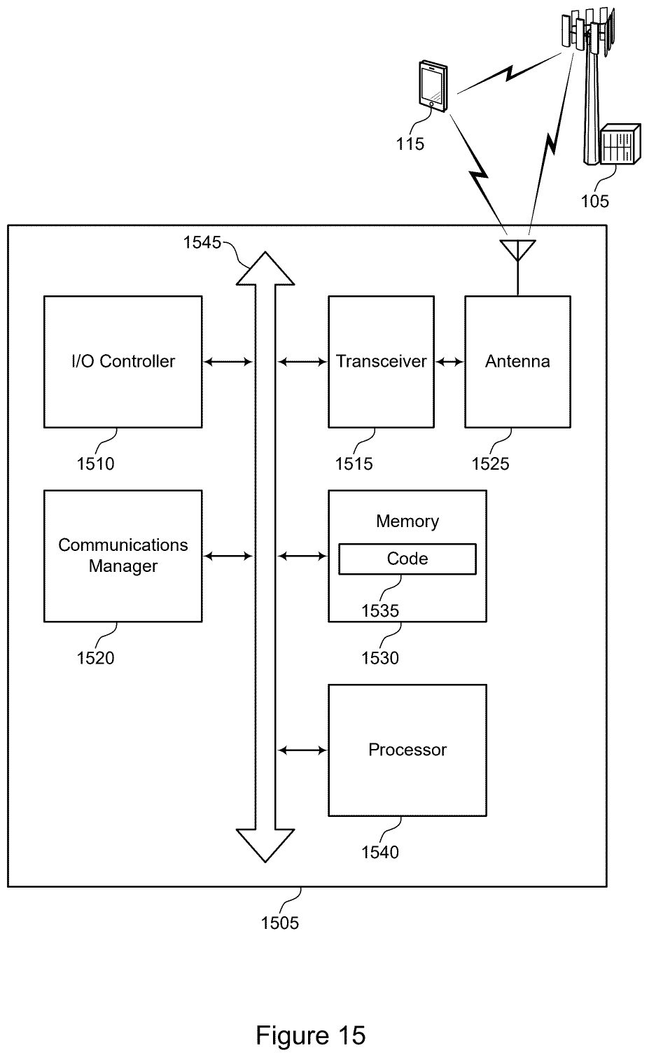

FIG. 15 shows a diagram of a system including a device 1505 associated with an example cancelation of an SPS PDSCH in accordance with one or more aspects of the present disclosure. The device 1505 may be an example of or include components of a device 1205, a device 1305, or a UE 115. The device 1505 may communicate (for example, wirelessly) with one or more other devices (for example, network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (for example, operatively, communicatively, functionally, electronically, electrically) via one or more buses (for example, a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (for example, when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (for example, the at least one memory 1530) to cause the device 1505 to perform various functions (for example, functions or tasks supporting cancelation of SPS PDSCH). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, being “configured to,” being “configurable to,” and being “operable to” may be used interchangeably and may be associated with a capability, when executing code 1535 (for example, processor-executable code) stored in the at least one memory 1530 or otherwise, to perform one or more of the functions described herein.

The communications manager 1520 may support wireless communication in accordance with examples as disclosed herein. For example, the communications manager 1520 is capable of, configured to, or operable to support a means for receiving control signaling that schedules a set of SPS PDSCH transmissions. The communications manager 1520 is capable of, configured to, or operable to support a means for transmitting a NACK for a first PDSCH transmission, the first PDSCH transmission associated with a HARQ ID. The communications manager 1520 is capable of, configured to, or operable to support a means for refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

By including or configuring the communications manager 1520 in accordance with described examples, the device 1505 may support techniques for improved communication reliability, reduced power consumption, more efficient utilization of communication resources, improved coordination between devices, and improved utilization of processing capability.

In some examples, the communications manager 1520 may be configured to perform various operations (for example, receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of cancelation of SPS PDSCH, or the at least one processor 1540 and the at least one memory 1530 may be otherwise configured to, individually or collectively, perform or support such operations.

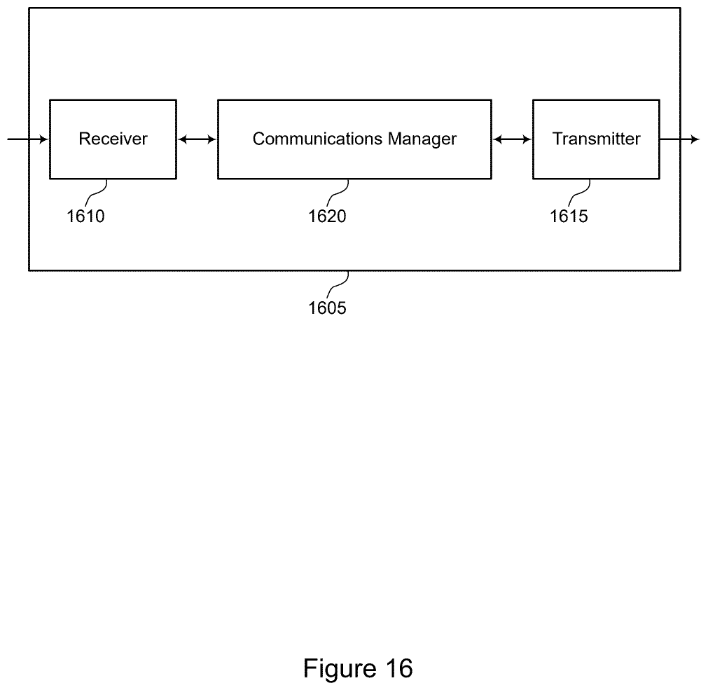

FIG. 16 shows a block diagram of a device 1605 associated with an example cancelation of an SPS PDSCH in accordance with one or more aspects of the present disclosure. The device 1605 may be an example of aspects of a network entity 105. The device 1605 may include a receiver 1610, a transmitter 1615, and a communications manager 1620. The device 1605, or one or more components of the device 1605 (for example, the receiver 1610, the transmitter 1615, the communications manager 1620), may include at least one processor, which may be coupled with at least one memory, to, individually or collectively, support or enable the described techniques. Each of these components may be in communication with one another (for example, via one or more buses). The communications manager 1620 can be implemented, at least in part, by one or both of a modem and a processor.

The receiver 1610 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (for example, electrical, fiber optic) interfaces, wireless interfaces, or any combination thereof.

The transmitter 1615 may provide a means for outputting (for example, transmitting, providing, conveying, sending) information generated by other components of the device 1605. For example, the transmitter 1615 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (for example, electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations or components thereof may be examples of means for performing various aspects of cancelation of SPS PDSCH. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (for example, in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (for example, by one or more processors, individually or collectively, executing instructions stored in the at least one memory).

If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (for example, configured as or otherwise supporting, individually or collectively, a means for performing the functions described in the present disclosure).

In some examples, the communications manager 1620 may be configured to perform various operations (for example, receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations.

The communications manager 1620 may support wireless communication in accordance with examples as disclosed herein. For example, the communications manager 1620 is capable of, configured to, or operable to support a means for transmitting, to a UE, control signaling that schedules a set of SPS PDSCH transmissions. The communications manager 1620 is capable of, configured to, or operable to support a means for receiving, from the UE, a NACK for a first PDSCH transmission, the first PDSCH transmission associated with a HARQ ID. The communications manager 1620 is capable of, configured to, or operable to support a means for refraining from transmitting, subsequent to and in accordance with reception of the NACK, an SPS PDSCH transmission of the set of SPS PDSCH transmissions in accordance with the SPS PDSCH transmission being associated with the same HARQ ID as the first PDSCH transmission.

By including or configuring the communications manager 1620 in accordance with described examples, the device 1605 (for example, at least one processor controlling or otherwise coupled with the receiver 1610, the transmitter 1615, the communications manager 1620, or a combination thereof) may support techniques for reduced power consumption and more efficient utilization of communication resources.

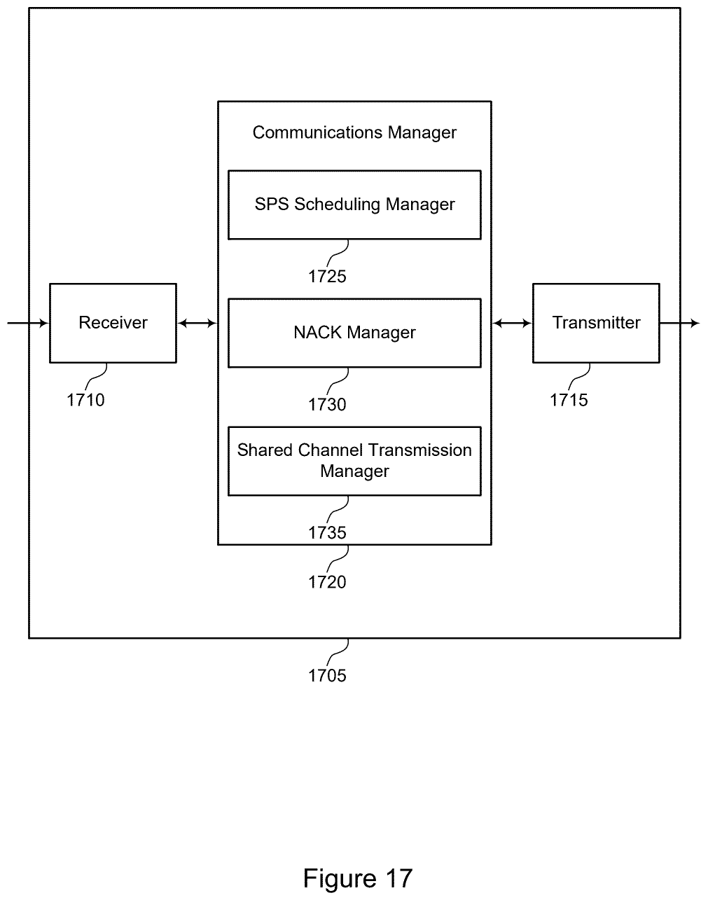

FIG. 17 shows a block diagram of a device 1705 associated with an example cancelation of an SPS PDSCH in accordance with one or more aspects of the present disclosure. The device 1705 may be an example of aspects of a device 1605 or a network entity 105. The device 1705 may include a receiver 1710, a transmitter 1715, and a communications manager 1720. The device 1705, or one or more components of the device 1705 (for example, the receiver 1710, the transmitter 1715, the communications manager 1720), may include at least one processor, which may be coupled with at least one memory, to support the described techniques. Each of these components may be in communication with one another (for example, via one or more buses). The communications manager 1720 can be implemented, at least in part, by one or both of a modem and a processor.

The receiver 1710 may provide a means for obtaining (for example, receiving, determining, identifying) information such as user data, control information, or any combination thereof (for example, I/Q samples, symbols, packets, protocol data units, service data units) associated with various channels (for example, control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (for example, electrical, fiber optic) interfaces, wireless interfaces, or any combination thereof.

The transmitter 1715 may provide a means for outputting (for example, transmitting, providing, conveying, sending) information generated by other components of the device 1705. For example, the transmitter 1715 may output information such as user data, control information, or any combination thereof (for example, I/Q samples, symbols, packets, protocol data units, service data units) associated with various channels (for example, control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (for example, electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of cancelation of SPS PDSCH. For example, the communications manager 1720 may include an SPS scheduling manager 1725, a NACK manager 1730, a shared channel transmission manager 1735, or any combination thereof. The communications manager 1720 may be an example of aspects of a communications manager 1620. In some examples, the communications manager 1720, or various components thereof, may be configured to perform various operations (for example, receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations.

The communications manager 1720 may support wireless communication in accordance with examples as disclosed herein. The SPS scheduling manager 1725 is capable of, configured to, or operable to support a means for transmitting, to a UE, control signaling that schedules a set of SPS PDSCH transmissions. The NACK manager 1730 is capable of, configured to, or operable to support a means for receiving, from the UE, a NACK for a first PDSCH transmission, the first PDSCH transmission associated with a HARQ ID. The shared channel transmission manager 1735 is capable of, configured to, or operable to support a means for refraining from transmitting, subsequent to and in accordance with reception of the NACK, an SPS PDSCH transmission of the set of SPS PDSCH transmissions in accordance with the SPS PDSCH transmission being associated with the same HARQ ID as the first PDSCH transmission.

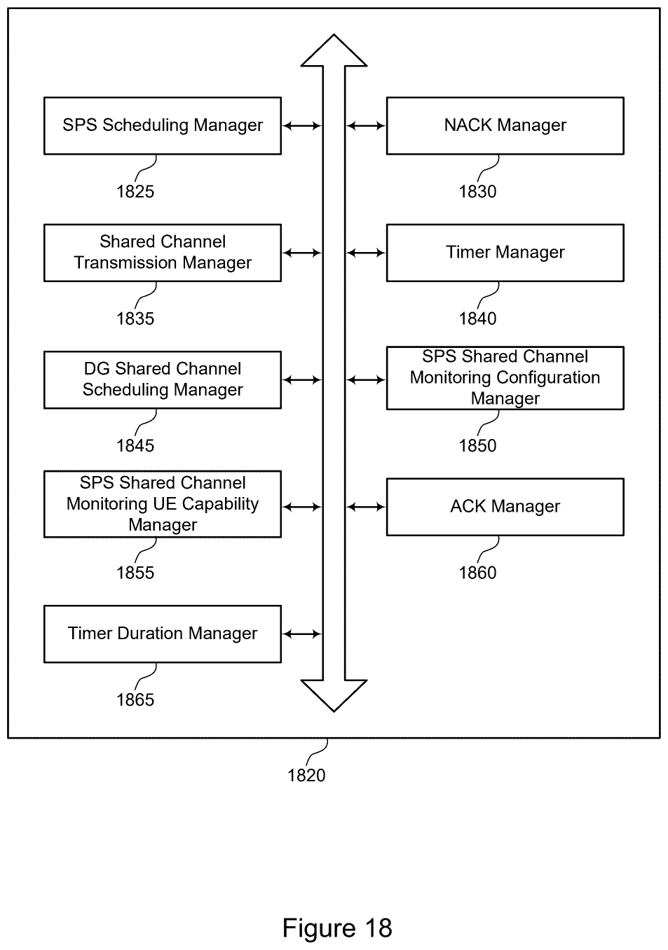

FIG. 18 shows a block diagram of a communications manager 1820 associated with an example cancelation of an SPS PDSCH in accordance with one or more aspects of the present disclosure. The communications manager 1820, or various components thereof, may be an example of means for performing various aspects of cancelation of SPS PDSCH. For example, the communications manager 1820 may include an SPS scheduling manager 1825, a NACK manager 1830, a shared channel transmission manager 1835, a timer manager 1840, a DG shared channel scheduling manager 1845, an SPS shared channel monitoring configuration manager 1850, an SPS shared channel monitoring UE capability manager 1855, an ACK manager 1860, a timer duration manager 1865, or any combination thereof. Each of these components, or components or subcomponents thereof (for example, one or more processors, one or more memories), may communicate, directly or indirectly, with one another (for example, via one or more buses). The communications may include communications within a protocol layer of a protocol stack, communications associated with a logical channel of a protocol stack (for example, between protocol layers of a protocol stack, within a device, component, or virtualized component associated with a network entity 105, between devices, components, or virtualized components associated with a network entity 105), or any combination thereof.

The communications manager 1820 may support wireless communication in accordance with examples as disclosed herein. The SPS scheduling manager 1825 is capable of, configured to, or operable to support a means for transmitting, to a UE, control signaling that schedules a set of SPS PDSCH transmissions. The NACK manager 1830 is capable of, configured to, or operable to support a means for receiving, from the UE, a NACK for a first PDSCH transmission, the first PDSCH transmission associated with a HARQ ID. The shared channel transmission manager 1835 is capable of, configured to, or operable to support a means for refraining from transmitting, subsequent to and in accordance with reception of the NACK, an SPS PDSCH transmission of the set of SPS PDSCH transmissions in accordance with the SPS PDSCH transmission being associated with the same HARQ ID as the first PDSCH transmission.

In some examples, the timer manager 1840 is capable of, configured to, or operable to support a means for starting a timer in accordance with reception of the NACK. Refraining from transmitting the SPS PDSCH transmission may be associated with the SPS PDSCH transmission being scheduled in a duration after starting the timer and before an expiration of the timer.

In some examples, the shared channel transmission manager 1835 is capable of, configured to, or operable to support a means for transmitting, to the UE after the expiration of the timer, a second SPS PDSCH transmission of the set of SPS PDSCH transmissions. The second SPS PDSCH transmission may be associated with the same HARQ ID.

In some examples, the DG shared channel scheduling manager 1845 is capable of, configured to, or operable to support a means for transmitting DCI that schedules a DG PDSCH transmission. The DG PDSCH transmission may be associated with the same HARQ ID. In some examples, the timer manager 1840 is capable of, configured to, or operable to support a means for starting or restarting the timer in association with transmission of the DCI that schedules the DG PDSCH transmission associated with the same HARQ ID.

In some examples, the ACK manager 1860 is capable of, configured to, or operable to support a means for receiving, from the UE, an ACK for a second PDSCH transmission. The second PDSCH transmission may be associated with the same HARQ ID. In some examples, the timer manager 1840 is capable of, configured to, or operable to support a means for terminating the timer in association with reception of the ACK. In some examples, the shared channel transmission manager 1835 is capable of, configured to, or operable to support a means for transmitting, to the UE after termination of the timer, a second SPS PDSCH transmission of the set of SPS PDSCH transmissions. The second SPS PDSCH transmission may be associated with the same HARQ ID.

In some examples, the timer duration manager 1865 is capable of, configured to, or operable to support a means for transmitting second control signaling that indicates the duration associated with the timer.

In some examples, the shared channel transmission manager 1835 is capable of, configured to, or operable to support a means for transmitting, to the UE, a second SPS PDSCH transmission of the set of SPS PDSCH transmissions. The second SPS PDSCH transmission may be associated with a second HARQ ID. In some examples, the DG shared channel scheduling manager 1845 is capable of, configured to, or operable to support a means for transmitting, to the UE and subsequent to the second SPS PDSCH transmission, DCI that schedules a DG PDSCH transmission. The DCI may indicate that the DG PDSCH transmission is associated with the second HARQ ID. The DCI may include an indication that the network entity transmitted the second SPS PDSCH transmission. In some examples, the shared channel transmission manager 1835 is capable of, configured to, or operable to support a means for transmitting the DG PDSCH transmission in accordance with the DCI.

In some examples, the shared channel transmission manager 1835 is capable of, configured to, or operable to support a means for refraining from transmitting a second SPS PDSCH transmission of the set of SPS PDSCH transmissions. The second SPS PDSCH transmission may be associated with a second HARQ ID. In some examples, the DG shared channel scheduling manager 1845 is capable of, configured to, or operable to support a means for transmitting, to the UE and subsequent to the second SPS PDSCH transmission, DCI that schedules a DG PDSCH transmission. The DCI may indicate that the DG PDSCH transmission is associated with the second HARQ ID. The DCI may include an indication that the network entity canceled the second SPS PDSCH transmission. In some examples, the shared channel transmission manager 1835 is capable of, configured to, or operable to support a means for transmitting the DG PDSCH transmission in accordance with the DCI.

In some examples, the DG shared channel scheduling manager 1845 is capable of, configured to, or operable to support a means for transmitting, to the UE subsequent to the SPS PDSCH transmission, DCI that schedules a DG PDSCH transmission. The DCI may indicate that the DG PDSCH transmission is associated with the same HARQ ID. The DCI may include an indication that the network entity canceled the SPS PDSCH transmission. In some examples, the shared channel transmission manager 1835 is capable of, configured to, or operable to support a means for transmitting, to the UE, the DG PDSCH transmission in accordance with the DCI.

In some examples, the SPS shared channel monitoring configuration manager 1850 is capable of, configured to, or operable to support a means for transmitting, to the UE, second control signaling that indicates a configuration to refrain from monitoring for one or more SPS PDSCH transmissions associated with a NACKed HARQ ID.

In some examples, the SPS shared channel monitoring UE capability manager 1855 is capable of, configured to, or operable to support a means for receiving, from the UE, capability signaling indicating a capability of the UE to support a configuration to refrain from monitoring for one or more SPS PDSCH transmissions associated with a NACKed HARQ ID.

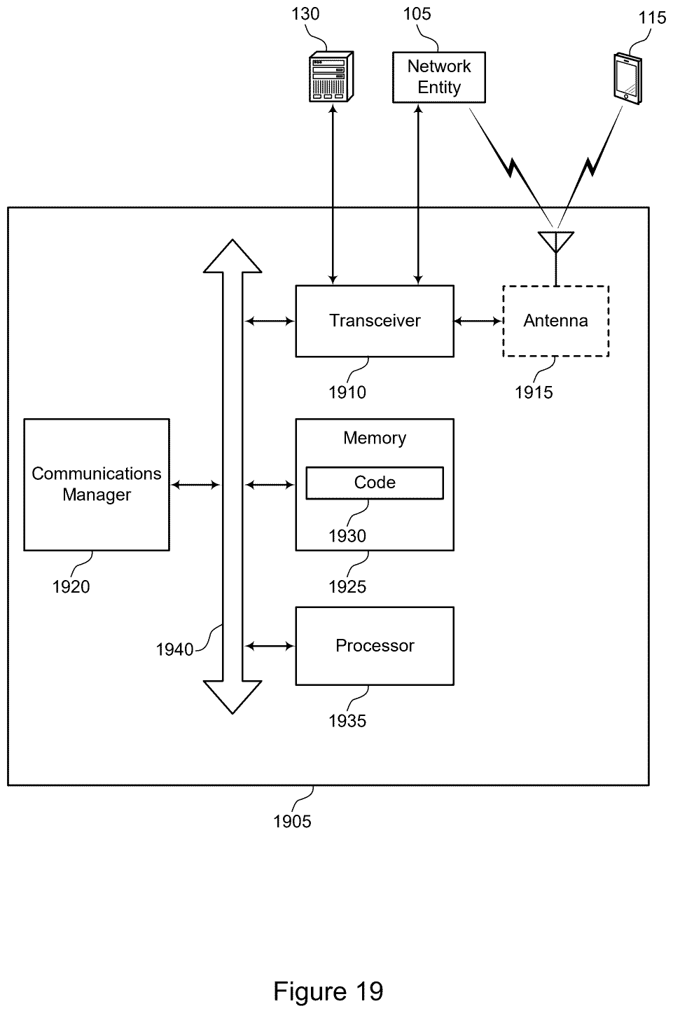

FIG. 19 shows a diagram of a system including a device 1905 associated with an example cancelation of an SPS PDSCH in accordance with one or more aspects of the present disclosure. The device 1905 may be an example of or include components of a device 1605, a device 1705, or a network entity 105. The device 1905 may communicate with other network devices or network equipment such as one or more of the network entities 105, UEs 115, or any combination thereof. The communications may include communications over one or more wired interfaces, over one or more wireless interfaces, or any combination thereof. The device 1905 may include components that support outputting and obtaining communications, such as a communications manager 1920, a transceiver 1910, one or more antennas 1915, at least one memory 1925, code 1930, and at least one processor 1935. These components may be in electronic communication or otherwise coupled (for example, operatively, communicatively, functionally, electronically, electrically) via one or more buses (for example, a bus 1940).

The transceiver 1910 may support bi-directional communications via wired links, wireless links, or both. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (for example, concurrently). The transceiver 1910 may also include a modem to modulate signals, to provide the modulated signals for transmission (for example, by one or more antennas 1915, by a wired transmitter), to receive modulated signals (for example, from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (for example, the at least one processor 1935, the at least one memory 1925, or both), may be included in a chip or chip assembly that is installed in the device 1905. In some examples, the transceiver 1910 may be operable to support communications via one or more communications links (for example, communication link(s) 125, backhaul communication link(s) 120, a midhaul communication link 162, a fronthaul communication link 168).

The at least one memory 1925 may include RAM, ROM, or any combination thereof. The at least one memory 1925 may store computer-readable, computer-executable, or processor-executable code, such as the code 1930. The code 1930 may include instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (for example, when compiled and executed) to perform functions described herein. In some cases, the at least one memory 1925 may include, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include one or more intelligent hardware devices (for example, one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (for example, one or more of the at least one memory 1925) to cause the device 1905 to perform various functions (for example, functions or tasks supporting cancelation of SPS PDSCH). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (for example, one or more physical nodes and supporting software such as operating systems, virtual machines, or container instances) that may host the functions (for example, by executing code 1930) to perform the functions of the device 1905. The at least one processor 1935 may be any one or more suitable processors capable of executing scripts or instructions of one or more software programs stored in the device 1905 (such as within one or more of the at least one memory 1925).

In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. For example, the at least one processor 1935 or a processing system including the at least one processor 1935 may be configured to, configurable to, or operable to cause the device 1905 to perform one or more of the functions described herein. Further, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (for example, within) a protocol layer of a protocol stack. In some examples, a bus 1940 may support communications associated with a logical channel of a protocol stack (for example, between protocol layers of a protocol stack), which may include communications performed within a component of the device 1905, or between different components of the device 1905 that may be co-located or located in different locations (for example, the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (for example, via one or more wired or wireless backhaul links). For example, the communications manager 1920 may manage the transfer of data communications for client devices, such as one or more UEs 115. In some examples, the communications manager 1920 may manage communications with one or more other network entities 105, and may include a controller or scheduler for controlling communications with UEs 115 (for example, in cooperation with the one or more other network devices). In some examples, the communications manager 1920 may support an X2 interface within an LTE/LTE-A wireless communications network technology to provide communication between network entities 105.

The communications manager 1920 may support wireless communication in accordance with examples as disclosed herein. For example, the communications manager 1920 is capable of, configured to, or operable to support a means for transmitting, to a UE, control signaling that schedules a set of SPS PDSCH transmissions. The communications manager 1920 is capable of, configured to, or operable to support a means for receiving, from the UE, a NACK for a first PDSCH transmission, the first PDSCH transmission associated with a HARQ ID. The communications manager 1920 is capable of, configured to, or operable to support a means for refraining from transmitting, subsequent to and in accordance with reception of the NACK, an SPS PDSCH transmission of the set of SPS PDSCH transmissions in accordance with the SPS PDSCH transmission being associated with the same HARQ ID as the first PDSCH transmission.

By including or configuring the communications manager 1920 in accordance with examples, the device 1905 may support techniques for improved communication reliability, reduced power consumption, more efficient utilization of communication resources, improved coordination between devices, and improved utilization of processing capability.

In some examples, the communications manager 1920 may be configured to perform various operations (for example, receiving, obtaining, monitoring, outputting, transmitting) using or otherwise in cooperation with the transceiver 1910, the one or more antennas 1915 (for example, where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of cancelation of SPS PDSCH, or the at least one processor 1935 and the at least one memory 1925 may be otherwise configured to, individually or collectively, perform or support such operations.

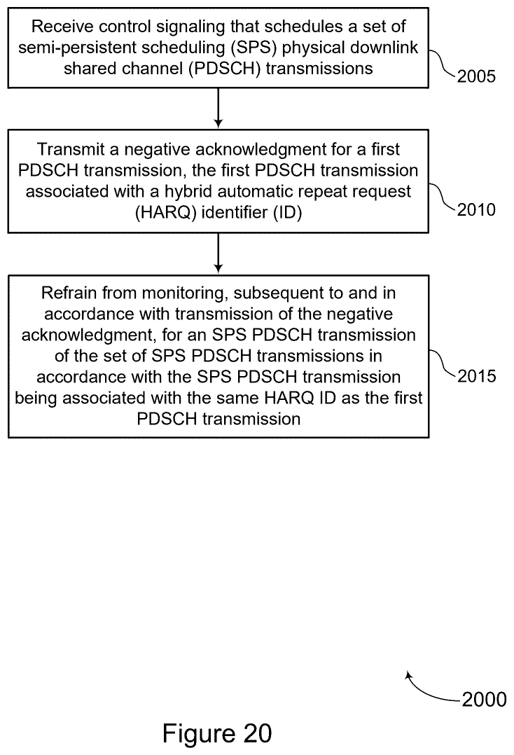

FIG. 20 shows a flowchart illustrating a method 2000 associated with an example cancelation of an SPS PDSCH in accordance with one or more aspects of the present disclosure. The operations of the method 2000 may be implemented by a UE or its components. For example, the operations of the method 2000 may be performed by a UE 115 as described with reference to FIGS. 1-15. In some examples, a UE may execute a set of instructions to control the functional elements of the UE to perform the described functions. Additionally, or alternatively, the UE may perform aspects of the described functions using special-purpose hardware.

At 2005, the method may include receiving control signaling that schedules a set of SPS PDSCH transmissions. The operations of 2005 may be performed in accordance with examples as disclosed herein. In some examples, aspects of the operations of 2005 may be performed by an SPS scheduling manager 1425 as described with reference to FIG. 14.

At 2010, the method may include transmitting a NACK for a first PDSCH transmission, the first PDSCH transmission associated with a HARQ ID. The operations of 2010 may be performed in accordance with examples as disclosed herein. In some examples, aspects of the operations of 2010 may be performed by a NACK manager 1430 as described with reference to FIG. 14.

At 2015, the method may include refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission. The operations of 2015 may be performed in accordance with examples as disclosed herein. In some examples, aspects of the operations of 2015 may be performed by an SPS shared channel monitoring manager 1435 as described with reference to FIG. 14.

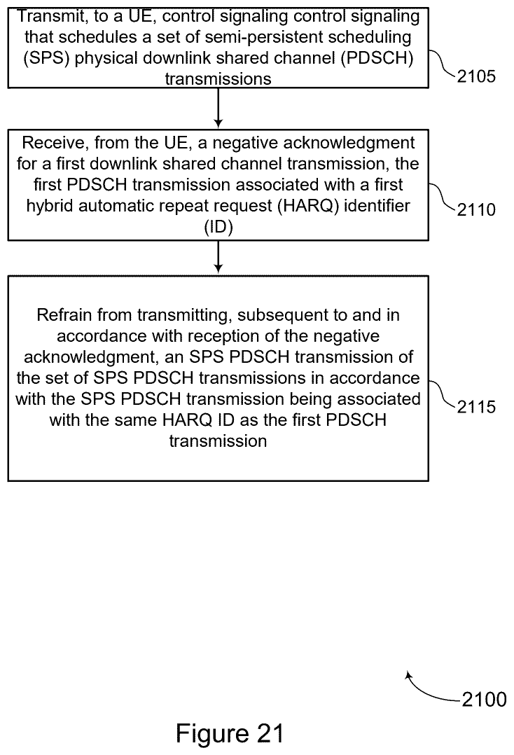

FIG. 21 shows a flowchart illustrating a method 2100 associated with an example cancelation of an SPS PDSCH in accordance with one or more aspects of the present disclosure. The operations of the method 2100 may be implemented by a network entity or its components. For example, the operations of the method 2100 may be performed by a network entity as described with reference to FIGS. 1-11 and 16-19. In some examples, a network entity may execute a set of instructions to control the functional elements of the network entity to perform the described functions. Additionally, or alternatively, the network entity may perform aspects of the described functions using special-purpose hardware.

At 2105, the method may include transmitting, to a UE, control signaling that schedules a set of SPS PDSCH transmissions. The operations of 2105 may be performed in accordance with examples as disclosed herein. In some examples, aspects of the operations of 2105 may be performed by an SPS scheduling manager 1825 as described with reference to FIG. 18.

At 2110, the method may include receiving, from the UE, a NACK for a first PDSCH transmission, the first PDSCH transmission associated with a HARQ ID. The operations of 2110 may be performed in accordance with examples as disclosed herein. In some examples, aspects of the operations of 2110 may be performed by a NACK manager 1830 as described with reference to FIG. 18.

At 2115, the method may include refraining from transmitting, subsequent to and in accordance with reception of the NACK, an SPS PDSCH transmission of the set of SPS PDSCH transmissions in accordance with the SPS PDSCH transmission being associated with the same HARQ ID as the first PDSCH transmission. The operations of 2115 may be performed in accordance with examples as disclosed herein. In some examples, aspects of the operations of 2115 may be performed by a shared channel transmission manager 1835 as described with reference to FIG. 18.

The following provides an overview of aspects of the present disclosure:

Aspect 1: A method for wireless communication by a UE, comprising: receiving control signaling that schedules a set of SPS PDSCH transmissions; transmitting a NACK for a first PDSCH transmission, the first PDSCH transmission associated with a first HARQ ID; and refraining from monitoring, subsequent to and in accordance with transmission of the NACK, for an SPS PDSCH transmission of the set of SPS PDSCH transmissions in accordance with the SPS PDSCH transmission being associated with the same HARQ ID as the first PDSCH transmission.

Aspect 2: The method of aspect 1, further comprising starting a timer in accordance with transmission of the NACK, wherein refraining from monitoring for the SPS PDSCH transmission is associated with the SPS PDSCH transmission being scheduled in a duration after starting the timer and before an expiration of the timer.

Aspect 3: The method of aspect 2, further comprising monitoring for, after the expiration of the timer, a second SPS PDSCH transmission of the set of SPS PDSCH transmissions, wherein the second SPS PDSCH transmission is associated with the same HARQ ID.

Aspect 4: The method of any of aspects 2 through 3, further comprising: receiving, downlink control information that schedules a DG PDSCH transmission, wherein the DG PDSCH transmission is associated with the same HARQ ID; and starting or restarting the timer in association with reception of the downlink control information that schedules the DG PDSCH transmission associated with the same HARQ ID.

Aspect 5: The method of any of aspects 2 through 4, further comprising: transmitting an acknowledgment for a second PDSCH transmission, wherein the second PDSCH transmission is associated with the same HARQ ID; terminating the timer in association with transmission of the acknowledgment; and monitoring for, after termination of the timer, a second SPS PDSCH transmission of the set of SPS PDSCH transmissions, wherein the second SPS PDSCH transmission is associated with the same HARQ ID.

Aspect 6: The method of any of aspects 2 through 5, further comprising receiving second control signaling that indicates the duration associated with the timer.

Aspect 7: The method of any of aspects 1 through 6, further comprising: monitoring for a second SPS PDSCH transmission of the set of SPS PDSCH transmissions, wherein the second SPS PDSCH transmission is associated with a second HARQ ID; transmitting a first acknowledgment for the second SPS PDSCH transmission; receiving, from a network entity and subsequent to the second SPS PDSCH transmission, downlink control information that schedules a DG PDSCH transmission, wherein the downlink control information indicates that the DG PDSCH transmission is associated with the second HARQ ID, and wherein the downlink control information includes an indication that the network entity canceled the second SPS PDSCH transmission; and transmitting, in association with the DG PDSCH transmission being associated with the same HARQ ID and in association with the transmission of the first acknowledgment, a second acknowledgment for the DG PDSCH transmission.

Aspect 8: The method of any of aspects 1 through 6, further comprising: monitoring for a second PDSCH transmission associated with a second HARQ ID; transmitting a second NACK for the second PDSCH transmission; monitoring for, subsequent to transmitting the second NACK, a second SPS PDSCH transmission of the set of SPS PDSCH transmissions, wherein the second SPS PDSCH transmission is associated with the second HARQ ID; receiving, from a network entity and subsequent to the second SPS PDSCH transmission, downlink control information that schedules a DG PDSCH transmission, wherein the downlink control information indicates that the DG PDSCH transmission is associated with the second HARQ ID, wherein the downlink control information includes an indication that the network entity canceled the second SPS PDSCH transmission; and monitoring for the DG PDSCH transmission in accordance with the downlink control information and in accordance with an interpretation that a new data indicator associated with the second HARQ ID indicates that the DG PDSCH transmission includes new data, wherein the interpretation is in association with transmission of the second NACK and the indication that the network entity canceled the second SPS PDSCH transmission.

Aspect 9: The method of any of aspects 1 through 6, further comprising: receiving, from a network entity and subsequent to the SPS PDSCH transmission, downlink control information that schedules a DG PDSCH transmission, wherein the downlink control information indicates that the DG PDSCH transmission is associated with the same HARQ ID, and wherein the downlink control information includes an indication that the network entity canceled the SPS PDSCH transmission; and monitoring for the DG PDSCH transmission in accordance with the downlink control information and in accordance with an interpretation that a new data indicator associated with the same HARQ ID that the DG PDSCH transmission includes retransmitted data, wherein the interpretation is in accordance with the transmission of the NACK and the indication that the network entity canceled the SPS PDSCH transmission.

Aspect 10: The method of any of aspects 1 through 6, further comprising: receiving, from a network entity and subsequent to the SPS PDSCH transmission, downlink control information that schedules a DG PDSCH transmission, wherein the downlink control information indicates that the DG PDSCH transmission is associated with the same HARQ ID, and wherein the downlink control information includes an indication that the network entity transmitted the SPS PDSCH transmission; and monitoring for the DG PDSCH transmission in accordance with the downlink control information and in accordance with an interpretation that a new data indicator associated with the same HARQ ID indicates that the DG PDSCH transmission includes new data, wherein the interpretation is in accordance with the indication that the network entity transmitted the SPS PDSCH transmission.

Aspect 11: The method of aspect 10, further comprising transmitting, to the network entity in association with the indication that the network entity transmitted the SPS PDSCH transmission and subsequent to reception of the downlink control information, a message indicating that the UE transmitted the NACK.

Aspect 12: The method of any of aspects 1 through 11, further comprising detecting an absence of a demodulation reference signal in a resource of the SPS PDSCH transmission, wherein refraining from monitoring for the SPS PDSCH transmission is further in association with detecting the absence of the demodulation reference signal.

Aspect 13: The method of any of aspects 1 through 12, further comprising receiving second control signaling that indicates a configuration to refrain from monitoring for one or more SPS PDSCH transmissions associated with a negatively acknowledged HARQ ID.

Aspect 14: The method of any of aspects 1 through 13, further comprising transmitting capability signaling indicating a capability of the UE to support a configuration to refrain from monitoring for one or more SPS PDSCH transmissions associated with a negatively acknowledged HARQ ID.

Aspect 15: A method for wireless communication by a network entity, comprising: transmitting, to a UE, control signaling that schedules a set of SPS PDSCH transmissions; receiving, from the UE, a NACK for a first PDSCH transmission, the first PDSCH transmission associated with a first HARQ ID; and refraining from transmitting, subsequent to and in accordance with reception of the NACK, an SPS PDSCH transmission of the set of SPS PDSCH transmissions in accordance with the SPS PDSCH transmission being associated with the same HARQ ID.

Aspect 16: The method of aspect 15, further comprising starting a timer in accordance with reception of the NACK, wherein refraining from transmitting the SPS PDSCH transmission is associated with the SPS PDSCH transmission being scheduled in a duration after starting the timer and before an expiration of the timer.

Aspect 17: The method of aspect 16, further comprising transmitting, to the UE after the expiration of the timer, a second SPS PDSCH transmission of the set of SPS PDSCH transmissions, wherein the second SPS PDSCH transmission is associated with the same HARQ ID.

Aspect 18: The method of any of aspects 16 through 17, further comprising: transmitting downlink control information that schedules a DG PDSCH transmission, wherein the DG PDSCH transmission is associated with the same HARQ ID; and starting or restarting the timer in association with transmission of the downlink control information that schedules the DG PDSCH transmission associated with the same HARQ ID.

Aspect 19: The method of any of aspects 16 through 18, further comprising: receiving, from the UE, an acknowledgment for a second PDSCH transmission, wherein the second PDSCH transmission is associated with the same HARQ ID; terminating the timer in association with reception of the acknowledgment; and transmitting, to the UE after termination of the timer, a second SPS PDSCH transmission of the set of SPS PDSCH transmissions, wherein the second SPS PDSCH transmission is associated with the same HARQ ID.

Aspect 20: The method of any of aspects 16 through 19, further comprising transmitting second control signaling that indicates the duration associated with the timer.

Aspect 21: The method of any of aspects 15 through 20, further comprising: transmitting, to the UE, a second SPS PDSCH transmission of the set of SPS PDSCH transmissions, wherein the second SPS PDSCH transmission is associated with a second HARQ ID; transmitting, to the UE and subsequent to the second SPS PDSCH transmission, downlink control information that schedules a DG PDSCH transmission, wherein the downlink control information indicates that the DG PDSCH transmission is associated with the second HARQ ID, wherein the downlink control information includes an indication that the network entity transmitted the second SPS PDSCH transmission; and transmitting the DG PDSCH transmission in accordance with the downlink control information.

Aspect 22: The method of any of aspects 15 through 20, further comprising: refraining from transmitting a second SPS PDSCH transmission of the set of SPS PDSCH transmissions, wherein the second SPS PDSCH transmission is associated with a second HARQ ID; transmitting, to the UE and subsequent to the second SPS PDSCH transmission, downlink control information that schedules a DG PDSCH transmission, wherein the downlink control information indicates that the DG PDSCH transmission is associated with the second HARQ ID, wherein the downlink control information includes an indication that the network entity canceled the second SPS PDSCH transmission; and transmitting the DG PDSCH transmission in accordance with the downlink control information.

Aspect 23: The method of any of aspects 15 through 20, further comprising: transmitting, to the UE subsequent to the SPS PDSCH transmission, downlink control information that schedules a DG PDSCH transmission, wherein the downlink control information indicates that the DG PDSCH transmission is associated with the same HARQ ID, and wherein the downlink control information includes an indication that the network entity canceled the SPS PDSCH transmission; and transmitting, to the UE, the DG PDSCH transmission in accordance with the downlink control information.

Aspect 24: The method of any of aspects 15 through 23, further comprising transmitting, to the UE, second control signaling that indicates a configuration to refrain from monitoring for one or more SPS PDSCH transmissions associated with a negatively acknowledged HARQ ID.

Aspect 25: The method of any of aspects 15 through 24, further comprising receiving, from the UE, capability signaling indicating a capability of the UE to support a configuration to refrain from monitoring for one or more SPS PDSCH transmissions associated with a negatively acknowledged HARQ ID.

Aspect 26: A UE, comprising a processing system that includes processor circuitry and memory circuitry that stores code, the processing system configured to cause the UE to perform a method of any of aspects 1 through 14.

Aspect 27: A UE for wireless communication, comprising at least one means for performing a method of any of aspects 1 through 14.

Aspect 28: A non-transitory computer-readable medium storing code for wireless communication, the code comprising instructions executable by one or more processors to perform a method of any of aspects 1 through 14.

Aspect 29: A network entity, a processing system that includes processor circuitry and memory circuitry that stores code, the processing system configured to cause the network entity to perform a method of any of aspects 15 through 25.

Aspect 30: A network entity for wireless communication, comprising at least one means for performing a method of any of aspects 15 through 25.

Aspect 31: A non-transitory computer-readable medium storing code for wireless communication, the code comprising instructions executable by one or more processors to perform a method of any of aspects 15 through 25.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, among other examples. Also, “determining” can include receiving (for example, receiving information), accessing (for example, accessing data stored in memory), among other examples. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling that schedules a set of semi-persistent scheduling (SPS) physical downlink shared channel (PDSCH) transmissions;
transmit a negative acknowledgment for a first PDSCH transmission, the first PDSCH transmission being associated with a first hybrid automatic repeat request (HARQ) identifier (ID); and
refrain from monitoring, subsequent to and in accordance with transmission of the negative acknowledgment, for an SPS PDSCH transmission of the set of SPS PDSCH transmissions in accordance with the SPS PDSCH transmission being associated with the same HARQ ID as the first PDSCH transmission.

2. The UE of claim 1, wherein the processing system is further configured to cause the UE to start a timer in accordance with transmission of the negative acknowledgment, wherein refraining from monitoring for the SPS PDSCH transmission is associated with the SPS PDSCH transmission being scheduled in a duration after starting the timer and before an expiration of the timer.

3. The UE of claim 2, wherein the processing system is further configured to cause the UE to monitor for, after the expiration of the timer, a second SPS PDSCH transmission of the set of SPS PDSCH transmissions, wherein the second SPS PDSCH transmission is associated with the same HARQ ID.

4. The UE of claim 2, wherein the processing system is further configured to cause the UE to:
receive downlink control information (DCI) that schedules a dynamic grant (DG) PDSCH transmission, wherein the DG PDSCH transmission is associated with the same HARQ ID; and
start or restart the timer in association with reception of the downlink control information in accordance with the DCI scheduling the DG PDSCH transmission associated with the same HARQ ID.

5. The UE of claim 2, wherein the processing system is further configured to cause the UE to:
transmit an acknowledgment for a second PDSCH transmission, wherein the second PDSCH transmission is associated with the same HARQ ID;
terminate the timer in association with transmission of the acknowledgment; and
monitor for, after termination of the timer, a second SPS PDSCH transmission of the set of SPS PDSCH transmissions, wherein the second SPS PDSCH transmission is associated with the same HARQ ID.

6. The UE of claim 2, wherein the processing system is further configured to cause the UE to receive second control signaling that indicates the duration associated with the timer.

7. The UE of claim 1, wherein the processing system is further configured to cause the UE to:
monitor for a second SPS PDSCH transmission of the set of SPS PDSCH transmissions, wherein the second SPS PDSCH transmission is associated with a second HARQ ID;
transmit a first acknowledgment for the second SPS PDSCH transmission;
receive, from a network entity and subsequent to the second SPS PDSCH transmission, downlink control information that schedules a dynamic grant (DG) PDSCH transmission, wherein the downlink control information indicates that the DG PDSCH transmission is associated with the second HARQ ID, and wherein the downlink control information includes an indication that the network entity canceled the second SPS PDSCH transmission; and
transmit, in association with the DG PDSCH transmission being associated with the same HARQ ID and in association with the transmission of the first acknowledgment, a second acknowledgment for the DG PDSCH transmission.

8. The UE of claim 1, wherein the processing system is further configured to cause the UE to:
monitor for a second PDSCH transmission associated with a second HARQ ID;
transmit a second negative acknowledgment for the second PDSCH transmission;
monitor for, subsequent to transmitting the second negative acknowledgment, a second SPS PDSCH transmission of the set of SPS PDSCH transmissions, wherein the second SPS PDSCH transmission is associated with the second HARQ ID;
receive, from a network entity and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity canceled the second SPS PDSCH transmission; and
monitor for the DG PDSCH transmission in accordance with the downlink control information and in accordance with an interpretation that a new data indicator (NDI) associated with the second HARQ ID indicates that the DG PDSCH transmission includes new data, wherein the interpretation is in association with transmission of the second negative acknowledgment and the indication that the network entity canceled the second SPS PDSCH transmission.

9. The UE of claim 1, wherein the processing system is further configured to cause the UE to:
receive, from a network entity and subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity canceled the SPS PDSCH transmission; and
monitor for the DG PDSCH transmission in accordance with the downlink control information and in accordance with an interpretation that a new data indicator (NDI) associated with the same HARQ ID that the DG PDSCH transmission includes retransmitted data, wherein the interpretation is in accordance with the transmission of the negative acknowledgment and the indication that the network entity canceled the SPS PDSCH transmission.

10. The UE of claim 1, wherein the processing system is further configured to cause the UE to:
receive, from a network entity and subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity transmitted the SPS PDSCH transmission; and
monitor for the DG PDSCH transmission in accordance with the downlink control information and in accordance with an interpretation that a new data indicator associated with the same HARQ ID indicates that the DG PDSCH transmission includes new data, wherein the interpretation is in accordance with the indication that the network entity transmitted the SPS PDSCH transmission.

11. The UE of claim 10, wherein the processing system is further configured to cause the UE to transmit, to the network entity in association with the indication that the network entity transmitted the SPS PDSCH transmission and subsequent to reception of the downlink control information, a message indicating that the UE transmitted the negative acknowledgment.

12. The UE of claim 1, wherein the processing system is further configured to cause the UE to detect an absence of a demodulation reference signal in a resource of the SPS PDSCH transmission, wherein refraining from monitoring for the SPS PDSCH transmission is further in association with detecting the absence of the demodulation reference signal.

13. The UE of claim 1, wherein the processing system is further configured to cause the UE to receive second control signaling that indicates a configuration to refrain from monitoring for one or more SPS PDSCH transmissions associated with a negatively-acknowledged HARQ ID.

14. The UE of claim 1, wherein the processing system is further configured to cause the UE to transmit capability signaling indicating a capability of the UE to support a configuration to refrain from monitoring for one or more SPS PDSCH transmissions associated with a negatively-acknowledged HARQ ID.

15. A network entity, comprising:
a processing system that includes processor circuitry and memory circuitry that stores code, the processing system configured to cause the network entity to:
transmit, to a user equipment (UE), control signaling that schedules a set of semi-persistent scheduling (SPS) physical downlink shared channel (PDSCH) transmissions;
receive, from the UE, a negative acknowledgment for a first PDSCH transmission, the first PDSCH transmission associated with a first hybrid automatic repeat request (HARQ) identifier (ID); and
refrain from transmitting, subsequent to and in accordance with reception of the negative acknowledgment, an SPS PDSCH transmission of the set of SPS PDSCH transmissions in accordance with the SPS PDSCH transmission being associated with the same HARQ ID as the first PDSCH transmission.

16. The network entity of claim 15, wherein the processing system is further configured to cause the network entity to start a timer in accordance with reception of the negative acknowledgment, wherein refraining from transmitting the SPS PDSCH transmission is associated with the SPS PDSCH transmission being scheduled in a duration after starting the timer and before an expiration of the timer.

17. The network entity of claim 16, wherein the processing system is further configured to cause the network entity to transmit, to the UE after the expiration of the timer, a second SPS PDSCH transmission of the set of SPS PDSCH transmissions, wherein the second SPS PDSCH transmission is associated with the same HARQ ID.

18. The network entity of claim 16, wherein the processing system is further configured to cause the network entity to:
transmit downlink control information that schedules a dynamic grant (DG) PDSCH transmission, wherein the DG PDSCH transmission is associated with the same HARQ ID; and
start or restart the timer in association with transmission of the downlink control information that schedules the DG PDSCH transmission associated with the same HARQ ID.

19. The network entity of claim 16, wherein the processing system is further configured to cause the network entity to:
receive, from the UE, an acknowledgment for a second PDSCH transmission, wherein the second PDSCH transmission is associated with the same HARQ ID;
terminate the timer in association with reception of the acknowledgment; and
transmit, to the UE after termination of the timer, a second SPS PDSCH transmission of the set of SPS PDSCH transmissions, wherein the second SPS PDSCH transmission is associated with the same HARQ ID.

20. The network entity of claim 16, wherein the processing system is further configured to cause the network entity to transmit second control signaling that indicates the duration associated with the timer.

21. The network entity of claim 15, wherein the processing system is further configured to cause the network entity to:
transmit, to the UE, a second SPS PDSCH transmission of the set of SPS PDSCH transmissions, wherein the second SPS PDSCH transmission is associated with a second HARQ ID;
transmit, to the UE and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity transmitted the second SPS PDSCH transmission; and
transmit the DG PDSCH transmission in accordance with the downlink control information.

22. The network entity of claim 15, wherein the processing system is further configured to cause the network entity to:
refrain from transmitting a second SPS PDSCH transmission of the set of SPS PDSCH transmissions, wherein the second SPS PDSCH transmission is associated with a second HARQ ID;
transmit, to the UE and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity canceled the second SPS PDSCH transmission; and
transmit the DG PDSCH transmission in accordance with the downlink control information.

23. The network entity of claim 15, wherein the processing system is further configured to cause the network entity to:
transmit, to the UE subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity canceled the SPS PDSCH transmission; and
transmit, to the UE, the DG PDSCH transmission in accordance with the downlink control information.

24. The network entity of claim 15, wherein the processing system is further configured to cause the network entity to transmit, to the UE, second control signaling that indicates a configuration to refrain from monitoring for one or more SPS PDSCH transmissions associated with a negatively acknowledged HARQ ID.

25. The network entity of claim 15, wherein the processing system is further configured to cause the network entity to receive, from the UE, capability signaling indicating a capability of the UE to support a configuration to refrain from monitoring for one or more SPS PDSCH transmissions associated with a negatively acknowledged HARQ ID.

26. A method for wireless communication by a user equipment (UE), comprising:
receiving control signaling that schedules a set of semi-persistent scheduling (SPS) physical downlink shared channel (PDSCH) transmissions;
transmitting a negative acknowledgment for a first PDSCH transmission, the first PDSCH transmission associated with a first hybrid automatic repeat request (HARQ) identifier (ID); and
refraining from monitoring, subsequent to and in accordance with transmission of the negative acknowledgment, for an SPS PDSCH transmission of the set of SPS PDSCH transmissions in accordance with the SPS PDSCH transmission being associated with the same HARQ ID as the first PDSCH transmission.

27. The method of claim 26, further comprising starting a timer in accordance with transmission of the negative acknowledgment, wherein refraining from monitoring for the SPS PDSCH transmission is associated with the SPS PDSCH transmission being scheduled in a duration after starting the timer and before an expiration of the timer.

28. The method of claim 27, further comprising monitoring for, after the expiration of the timer, a second SPS PDSCH transmission of the set of SPS PDSCH transmissions, wherein the second SPS PDSCH transmission is associated with the same HARQ ID.

29. The method of claim 27, further comprising:
receiving, downlink control information that schedules a dynamic grant (DG) PDSCH transmission, wherein the DG PDSCH transmission is associated with the same HARQ ID; and
starting or restarting the timer in association with reception of the downlink control information that schedules the DG PDSCH transmission associated with the same HARQ ID.

30. The method of claim 27, further comprising:
transmitting an acknowledgment for a second PDSCH transmission, wherein the second PDSCH transmission is associated with the same HARQ ID;
terminating the timer in association with transmission of the acknowledgment; and
monitoring for, after termination of the timer, a second SPS PDSCH transmission of the set of SPS PDSCH transmissions, wherein the second SPS PDSCH transmission is associated with the same HARQ ID.

31. The method of claim 27, further comprising receiving second control signaling that indicates the duration associated with the timer.

32. The method of claim 26, further comprising:
monitoring for a second SPS PDSCH transmission of the set of SPS PDSCH transmissions, wherein the second SPS PDSCH transmission is associated with a second HARQ ID;
transmitting a first acknowledgment for the second SPS PDSCH transmission;
receiving, from a network entity and subsequent to the second SPS PDSCH transmission, downlink control information that schedules a dynamic grant (DG) PDSCH transmission, wherein the downlink control information indicates that the DG PDSCH transmission is associated with the second HARQ ID, and wherein the downlink control information includes an indication that the network entity canceled the second SPS PDSCH transmission; and
transmitting, in association with the DG PDSCH transmission being associated with the same HARQ ID and in association with the transmission of the first acknowledgment, a second acknowledgment for the DG PDSCH transmission.

33. The method of claim 26, further comprising:
monitoring for a second PDSCH transmission associated with a second HARQ ID;
transmitting a second negative acknowledgment for the second PDSCH transmission;
monitoring for, subsequent to transmitting the second negative acknowledgment, a second SPS PDSCH transmission of the set of SPS PDSCH transmissions, wherein the second SPS PDSCH transmission is associated with the second HARQ ID;
receiving, from a network entity and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity canceled the second SPS PDSCH transmission; and
monitoring for the DG PDSCH transmission in accordance with the downlink control information and in accordance with an interpretation that a new data indicator associated with the second HARQ ID indicates that the DG PDSCH transmission includes new data, wherein the interpretation is in association with transmission of the second negative acknowledgment and the indication that the network entity canceled the second SPS PDSCH transmission.

34. The method of claim 26, further comprising:
receiving, from a network entity and subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity canceled the SPS PDSCH transmission; and
monitoring for the DG PDSCH transmission in accordance with the downlink control information and in accordance with an interpretation that a new data indicator associated with the same HARQ ID that the DG PDSCH transmission includes retransmitted data, wherein the interpretation is in accordance with the transmission of the negative acknowledgment and the indication that the network entity canceled the SPS PDSCH transmission.

35. The method of claim 26, further comprising:
receiving, from a network entity and subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity transmitted the SPS PDSCH transmission; and
monitoring for the DG PDSCH transmission in accordance with the downlink control information and in accordance with an interpretation that a new data indicator associated with the same HARQ ID indicates that the DG PDSCH transmission includes new data, wherein the interpretation is in accordance with the indication that the network entity transmitted the SPS PDSCH transmission.

36. The method of claim 35, further comprising transmitting, to the network entity in association with the indication that the network entity transmitted the SPS PDSCH transmission and subsequent to reception of the downlink control information, a message indicating that the UE transmitted the negative acknowledgment.

37. The method of claim 26, further comprising detecting an absence of a demodulation reference signal in a resource of the SPS PDSCH transmission, wherein refraining from monitoring for the SPS PDSCH transmission is further in association with detecting the absence of the demodulation reference signal.

38. The method of claim 26, further comprising receiving second control signaling that indicates a configuration to refrain from monitoring for one or more SPS PDSCH transmissions associated with a negatively acknowledged HARQ ID.

39. The method of claim 26, further comprising transmitting capability signaling indicating a capability of the UE to support a configuration to refrain from monitoring for one or more SPS PDSCH transmissions associated with a negatively acknowledged HARQ ID.

40. A method for wireless communication by a network entity, comprising:
transmitting, to a user equipment (UE), control signaling that schedules a set of semi-persistent scheduling (SPS) physical downlink shared channel (PDSCH) transmissions;
receiving, from the UE, a negative acknowledgment for a first PDSCH transmission, the first PDSCH transmission associated with a first hybrid automatic repeat request (HARQ) identifier (ID); and
refraining from transmitting, subsequent to and in accordance with reception of the negative acknowledgment, an SPS PDSCH transmission of the set of SPS PDSCH transmissions in accordance with the SPS PDSCH transmission being associated with the same HARQ ID.

41. The method of claim 40, further comprising starting a timer in accordance with reception of the negative acknowledgment, wherein refraining from transmitting the SPS PDSCH transmission is associated with the SPS PDSCH transmission being scheduled in a duration after starting the timer and before an expiration of the timer.

42. The method of claim 41, further comprising transmitting, to the UE after the expiration of the timer, a second SPS PDSCH transmission of the set of SPS PDSCH transmissions, wherein the second SPS PDSCH transmission is associated with the same HARQ ID.

43. The method of claim 41, further comprising:
transmitting downlink control information that schedules a dynamic grant (DG) PDSCH transmission, wherein the DG PDSCH transmission is associated with the same HARQ ID; and
starting or restarting the timer in association with transmission of the downlink control information that schedules the DG PDSCH transmission associated with the same HARQ ID.

44. The method of claim 41, further comprising:
receiving, from the UE, an acknowledgment for a second PDSCH transmission, wherein the second PDSCH transmission is associated with the same HARQ ID;
terminating the timer in association with reception of the acknowledgment; and
transmitting, to the UE after termination of the timer, a second SPS PDSCH transmission of the set of SPS PDSCH transmissions, wherein the second SPS PDSCH transmission is associated with the same HARQ ID.

45. The method of claim 41, further comprising transmitting second control signaling that indicates the duration associated with the timer.

46. The method of claim 40, further comprising:
transmitting, to the UE, a second SPS PDSCH transmission of the set of SPS PDSCH transmissions, wherein the second SPS PDSCH transmission is associated with a second HARQ ID;
transmitting, to the UE and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity transmitted the second SPS PDSCH transmission; and
transmitting the DG PDSCH transmission in accordance with the downlink control information.

47. The method of claim 40, further comprising:
refraining from transmitting a second SPS PDSCH transmission of the set of SPS PDSCH transmissions, wherein the second SPS PDSCH transmission is associated with a second HARQ ID;
transmitting, to the UE and subsequent to the second SPS PDSCH transmission, downlink control information that schedules a dynamic grant (DG) PDSCH transmission, wherein the downlink control information indicates that the DG PDSCH transmission is associated with the second HARQ ID, wherein the downlink control information includes an indication that the network entity canceled the second SPS PDSCH transmission; and
transmitting the DG PDSCH transmission in accordance with the downlink control information.

48. The method of claim 40, further comprising:
transmitting, to the UE subsequent to the SPS PDSCH transmission, downlink control information that schedules a dynamic grant (DG) PDSCH transmission, wherein the downlink control information indicates that the DG PDSCH transmission is associated with the same HARQ ID, and wherein the downlink control information includes an indication that the network entity canceled the SPS PDSCH transmission; and
transmitting, to the UE, the DG PDSCH transmission in accordance with the downlink control information.

49. The method of claim 40, further comprising transmitting, to the UE, second control signaling that indicates a configuration to refrain from monitoring for one or more SPS PDSCH transmissions associated with a negatively acknowledged HARQ ID.

50. The method of claim 40, further comprising receiving, from the UE, capability signaling indicating a capability of the UE to support a configuration to refrain from monitoring for one or more SPS PDSCH transmissions associated with a negatively acknowledged HARQ ID.
